(19) United States
(12) Patent Application Publication
(10) Pub. No.: US 2004/0260543 A1
(43) Pub. Date: Dec. 23, 2004

(54) Pattern cross-matching

(76) Inventors: David Horowitz, London (GB); Peter Phelan, London (GB); Kerry Robinson, Surrey (GB)

Correspondence Address: OSHA & MAY L.L.P., 1221 MCKINNEY STREET, HOUSTON, TX, 77010, US

(21) Appl. No.: 10/482,428

(22) PCT Filed: Jun. 28, 2002
(86) PCT No.: PCT/GB02/03013

(30) Foreign Application Priority Data
Jun. 28, 2001 (GB) 0115872.4

(51) Int. Cl. G10L 19/12

(52) U.S. Cl. 704/221

(57) ABSTRACT

Disclosed is a data selection mechanism for identifying a single data item from a plurality of data items, each data item having an associated plurality of related descriptors each having an asscoiated descriptor value. The data selection mechanism comprises a pattern matching mechanism for identifying candidate matching descriptor values that correspond to user-generated input, and a filter mechanism for providing a filtered data set comprising the single data item. The pattern matching mechanism is operable to apply one or more pattern recognition models to first user-generated intpu to generate one or more hypothesised descriptor values for each of the one or more pattern recognition models. The filter mechanism is operable to: 9) create a data filter from the hypothesised descriptor values produced by the one or more pattern recognition models to apply to the plurality of data items to produce a filtered data set of candidate data items; and ii) select one or more subsequent pattern recognition modesl for applying to further user-generated input.

The present invention relates to pattern matching. In particular, it relates to use of pattern matching to enable a single data item to be identified from among a plurality of data items.

In one example embodiment, the invention is applied to one or more data processing apparatus providing a spoken language interface (SLI) mechanism between a computer system and one or more users to enable the spoken language interface to more effectively identify addresses, user locations, identities etc. from incoming user-generated input, such as, for example, speech input.

There are many applications in which it is desirable to be able to identify a single item from among a plurality of items where the individual data items collectively define a set of unique data items.

For example, it may be desirable to identify a person's work e-mail address from the set of all e-mail addresses currently in existence from a limited set of descriptors, such as, for example, a person's name and work telephone number provided as user-generated input from typed, spoken or written input. However, the descriptor values identified from the user-generated input may or may not provide enough information to be able to identify only a single data item from among the plurality of data items. E.g. there may be more than one John Smith working for company X (the employee name descriptor being ambiguous), or there may be several interpretations of the user-generated input (e.g. the speech input relating to the descriptor value “John Smith” might be similar, and thus easily confused, with other descriptor values, like “Joan Smith” or “John Smythe”, for example.)

The problem of identifying a single data item from the available plurality of data items is one which is easily addressed when human intervention is available. E.g. someone desirous of identifying the e-mail address of John Smith who's work telephone number is 1234-5678 may call the switchboard and ask “Can I have John Smith's e-mail address” t o which they may receive the reply “Which John Smith: John Smith in accounts, IT or the patent department?” (this being the case where the descriptor is ambiguous) or “Is that Smith with an ‘I’ or Smythe with a ‘Y’?” (in the case of an ambiguous descriptor value). Such replies help disambiguate the information content of user-generated input by seeking a value for a further descriptor (e.g. the company department) to enable the single data item (e.g. the e-mail address) to be uniquely identified.

Although such a disambiguation process occurs naturally to humans, it is very difficult to provide such intelligence in an automated system such as, for example, a voice controlled system, even where there is only a limited set of possible data items (e.g. used as machine outputs) and descriptors (e.g. used as machine inputs). The difficulty of providing anything approaching an automated system that passes the so-called Turing test is ample testament to this difficulty for the case of an essentially infinite set of possible data items and descriptors; and it is essentially this problem that is approached as the size of the set of possible data items grows.

Various approaches have been taken to address the issue of identifying a single data item having various associated descriptors, from among a plurality of data items in a set. One approach used in the field of automated speech recognition applied to the recognition of an address is described in patent application number GB-A-2,362,746.

GB-A-2,362,746 describes a method of operating a computer to identify information desired by a user from two input speech signals. The first speech signal is recognised and used to constrain possible candidate values for recognition using the second speech signal. Although this method can be considered an improvement on previous methods, the method expects a user to provide first and second inputs of a specific type and in a specific order. This constrains the user input, and can lead to an automated speech recognition system employing the method that appears somewhat unnatural to the user. The user experience of the automated speech recognition system of GB-A-2,362,746 is further slowed and frustrated by the method since when the method fails to provide a recognition, user input needs to be repeated and/or a call transferred to a human operator. Such failed recognitions may occur all-too-frequently because the method does not provide a system that can optimally identify the information desired by the user. Furthermore, the method is not readily adaptable to be flexibly applied to systems that are not for address recognition.

One objective of the invention is therefore to provide a data selection mechanism/method that can provide a more natural user experience (e.g. by analysing user-generated input in a non-predetermined order, such as by way of a non-directed dialogue when employed in a spoken language interface embodiment) and which is also more accurate and/or efficient and/or faster at identifying any candidate single data item. Another objective of the invention is to provide a data selection mechanism/method that can be readily adapted for use in multiple applications, including, for example, spoken language interfaces. A further objective of the invention is to provide a data selection mechanism/method that can automatically recover when it fails to identify a candidate single data item from a plurality of data items.

According to a first aspect of the invention, there is provided a data selection mechanism for identifying a single data item from a plurality of data items. Each data item has an associated plurality of related descriptors each having an associated descriptor value. The data items may correspond to records in a database. The data selection mechanism comprises: a pattern matching mechanism for identifying candidate matching descriptor values that correspond to user-generated input. The pattern matching mechanism is operable to apply one or more pattern recognition models to first user-generated input to generate zero or more hypothesised descriptor values for each of the one or more pattern recognition models. The hypothesised descriptor values may be weighted. The data selection mechanism also comprises a filter mechanism for providing a filtered data set comprising the single data item. The filter mechanism is operable to: i) create a data filter from the hypothesised descriptor values produced by said one or more pattern recognition model to apply to the plurality of data items to produce a filtered data set of candidate data items; and ii) select and/or generate one or more subsequent pattern recognition models for applying to further user-generated input.

By enabling the selection and/or generation of pattern recognition models by the data selection mechanism, this aspect of the invention enables more efficient selection of any single data item. The selection can be achieved using fewer applications of the pattern matching models to the data items, and this speeds up selection. It further permits dynamic selection and/or of the pattern matching models in a way that allows non-directed dialogue to be provided as user-generated input. Additionally, this aspect of the invention can automatically determine the optimal user-generated input channel from which to take user-generated input (e.g. speech, keyed input etc) that will lead to efficient selection of the single data item.

The data selection mechanism may be operable to select and/or generate said at least one pattern matching models in accordance with the number of previous descriptor hypotheses with which said at least one pattern matching models are consistent. Pattern matching models, such as, for example, a grammar, may have entries that are weighted according to the number of previous descriptor hypotheses with which they are consistent. Multiple hypotheses may be stored during the operation of the data selection mechanism. Hypotheses may be pruned/discarded in dependence upon constraint violation criteria, and/or descriptor mismatches. Hypotheses may be pruned/discarded according to confidence, probability or a distance measure, e.g. by pruning the n-best lists according to a confidence threshold.

Each hypothesised descriptor value may have an associated confidence value. Data filter criteria may correspond to descriptors for which the associated confidence value of the descriptors exceeds a predetermined threshold confidence value. Use of confidence measures allows the data selection mechanism to handle ambiguous user-generated input.

The data selection mechanism may comprise a dynamic ordering mechanism for controlling the order in which user-generated input is analysed by the pattern matching mechanism. The dynamic ordering mechanism may further be operable to apply an information gain heuristic to the descriptors of the data items in the filtered data set to determine an ordered set of descriptors ranked according to the amount of additional information the associated descriptor values will provide. Use of a dynamic ordering mechanism enables the data selection mechanism to elicit (in an on-line system) or select (in an offline system) user generated input that is most likely to provide a filtered data set that is minimised in size and/or most likely to contain the single data item and/or will more rapidly identify the single data item. This may in turn lead to improved selection accuracy and/or speed. Furthermore, it also enables the data selection mechanism to flexibly adapt to a wide range of applications.

User-generated input can be requested from a user. For example, further user-generated input may be requested from a user where a filtered data set does not include a single candidate data item. User-generated input may be provided by a user interacting simultaneously with the data selection mechanism, e.g. during a telephone dialogue with a spoken language interface mechanism, and/or may be provided from one or more predetermined user-generated input. Predetermined user-generated input can be user input that has been stored, e.g. off-line.

Examples of user-generated input include, but are not limited to, input provided in the form of at least one of: a GPS or other electronic location related information data input, keyed input, text input, spoken input, audible input, written input, graphic input, etc.

The data selection mechanism may comprise an error recovery mechanism for performing an error recovery operation should the filtered data set be an empty set. The error recovery mechanism can automatically restart the data selection mechanism to try to identify the single data item again. This allows the data selection mechanism to minimise the number of times the same user-generated information is needed or must be requested from a user, and thus leads to a more natural user interface.

The filter mechanism may comprise a hypothesis history repository for storing hypotheses generated by the pattern matching mechanism. Any subsequent pattern recognition models may then be generated in dependence upon the hypotheses in the hypothesis history repository. This enables the data selection mechanism to perform more accurate selection, and consequently may also lead to more rapid identification of the single data item.

One example application of this aspect of the invention includes a spoken language interface mechanism. The data selection mechanism may include a pattern matching mechanism that performs voice recognition. The spoken language interface mechanism can be used, for example, for identifying one or more of: a spoken address, an e-mail address, a car registration plate, identification numbers, policy numbers and a physical location.

According to a second aspect of the present invention, there is provided a method for identifying a single data item from a plurality of data items, each data item having an associated plurality of related descriptors each having an associated descriptor value. The method comprises: a) operating a pattern matching mechanism to apply one or more pattern recognition models to user-generated input and generating zero or more hypothesised descriptor values for each of the one or more pattern recognition models; b) creating a data filter from the hypothesised descriptor values produced by the one or more pattern recognition model and applying the data filter to the plurality of data items to produce a filtered data set of candidate data items; and c) dynamically selecting and/or generating one or more further pattern recognition models and repeating steps a) and b) until a final filtered data set contains either the single data item, zero data items or there are no more descriptors left to consider.

The method according to this aspect of the invention provides the advantages associated with the data selection mechanism according to the first aspect of the invention. Method steps corresponding to aspects of the data selection mechanism may also be provided.

According to a third aspect of the invention, there is provided a program product comprising a carrier medium having program instruction code embodied in said carrier medium. The program instruction code comprises instructions for configuring at least one data processing apparatus to provide the data selection mechanism according to the first aspect of the invention, a spoken language interface mechanism incorporating a data selection mechanism according to the first aspect of the invention, or implement the method according to the second aspect of the invention. The program product may include at least one of the following set of media: a radio-frequency signal, an optical signal, an electronic signal, a magnetic disc or tape, solid-state memory, an optical disc, a magneto-optical disc, a compact disc and a digital versatile disc.

According to a fourth aspect of the invention, there is provided a data processing mechanism that comprises at least one data processing apparatus configured to provide the data selection mechanism according to the first aspect of the invention, a spoken language interface mechanism incorporating a data selection mechanism according to the first aspect of the invention, or implement the method according to the second aspect of the invention.

In various embodiments of the invention, data items and the associated related descriptors may be held as records in a database. Such a database can be incorporated into various existing systems, such as, for example, a spoken language interface of the type described in Vox Generation's patent application number PCT/GB02/00878. The database may thus be retroactively incorporated into existing systems to upgrade their capabilities.

Descriptors themselves may be dynamically generated or modified. The descriptors may be acquired from different sources. In one example, two or more of the descriptors relate to information obtained from different information channels, such as, for example, one descriptor corresponding to a possible voice input and another to a possible keypad input from a mobile telephone.

Aspects of the invention may be applied to data items having related descriptors that derive from different sources, information channels etc. For example, one descriptor may relate to information that derives from a voice channel and another descriptor to information that derives from a Dual Tone Multi-Frequency (DTMF) channel. The application of pattern matching to identify data items through an analysis of multiple associated descriptors that may or may not relate to information deriving from one or more different channels is known as multi-channel disambiguation (MCD). Use of MCD with aspects of the invention is particularly beneficial as it can provide for more accurate and/or faster identification of any relevant single data item from a plurality of data items by providing better data selection of data items.

Certain embodiments relate generally to speech recognition and, more specifically, to the recognition of address information by an automatic speech recognition unit (ASR) for example within a spoken language interface.

Providing accurate address information is essential in order successfully to carry out many business and administrative operations. In particular, call centre operations have to process vast numbers of addresses on a daily basis. Electronically automated assistance in this processing task would provide an immense benefit to the call centre, both in reducing costs and improving efficiency (ie response times). Within a suitable software architecture, such a solution would be highly scalable, so that very large numbers of simultaneous calls can be handled.

In a person-to-person call-centre environment, it is usually sufficient for two (sometimes three) pieces of information (descriptors) to be demanded of callers, viz., their postcode, and their house number to identify the address (data item) uniquely from a plurality of addresses. This is because a postcode such as that used in the United Kingdom, normally identifies a small number of neighbouring houses: the house number, or the name of the householder is then usually sufficient to identify an address uniquely. Some addresses; (mainly businesses), receive so much mail that they do not share their postcode with other properties—in such cases the postcode itself is equivalent to the address.

Within the UK, the call centre worker will typically ask for the first part of the postcode, then the second part, and finally the house name or number. Sometimes, when confirmation is required, a town name or street name will be requested from the caller.

Accurate and reliable recognition of postcodes is a difficult problem. This is essentially because there are generally a number of candidate postcodes which ‘sound similar,’ from the perspective of the ASR (Automatic Speech Recogniser).

Within a Spoken Language Interface (SLI), a key component is the automated speech recogniser (ASR). Generally, ASRs can only achieve high accuracy for restricted classes of utterances. Usually a grammar is used which encapsulates the class of utterances. Since there is an upper limit on the size of such grammars it is not feasible simply to use an exhaustive list of all the required addresses in an address recognition system as the foundation for the grammar. Moreover, such an approach would not exploit the structural relationships between each component of the address.

Vocalis Ltd of Cambridge, England has produced a demonstration system in which a user is asked for their postcode. The user is further asked for the street name. The system then offers an answer as to what the postcode was, and seeks confirmation from the user. Sometimes the system offers no answer.

Spoken language interfaces deploy Automatic Speech Recognition (ASR) technology which even under optimal conditions generally result in recognition accuracies significantly below 100%. Moreover, they can only achieve accurate recognition within finite domains. Typically, a grammar is used to specify all and only the expressions which can be recognised. The grammar is a kind of algebraic notation, which is used as a convenient shorthand, instead of having to write out every sentence in full.

A problem with the Vocalis demonstration system is that as soon as any problem is encountered the system defaults to the human operator. Thus, there is a need for a recognition system that is less reliant on human support. One aspect of the invention aims to provide such a system.

One embodiment of the invention provides a system which uses the structured nature of postcodes as the basis for address recognition.

According to one further aspect of the invention, there is provided a method of recognising an address spoken by a user using a spoken language interface, comprising the steps of forming a grammar of postcodes; asking the user for a postcode and forming a first list of the n-best recognition results; asking the user for a street name and forming a second list of the n-best recognition results, the dynamic grammar for which is predicated on the n-best results for the original postcode recognition; cross matching the first and second list to form a first match (matchesl); if the first match is positive, selecting an element from the match according to a predetermined criterion and confirming the selected match with the user; if the match is zero or the user does not confirm the match, asking the user for a first portion of the postcode and forming a third list of the n-best recognition results; asking the user for a town name and forming a fourth list of the n-best recognition results; cross matching the third and fourth lists to form a second match; if the second match has more or less than a single entry, passing the user from the spoken language interface to a human operator; if the second match has a single entry, confirming the entry with the user; and passing the user from the spoken language interface to a human operator if the user does not confirm the entry.

According to another aspect of the invention there is provided a spoken language interface, comprising: an automatic speech recognition unit for recognising utterances by a user; a speech unit for generating spoken prompts for the user; a first database having stored therein a plurality of postcodes; a second database, associated with the first database, having stored therein a plurality of street names; a third database associated with the first and second databases having stored therein a plurality of town names; and an address recognition unit for recognising an address spoken by the user, the address recognition unit comprising: a static grammar of postcodes using postcodes stored in the first database; means for forming a first list of n-best recognition results from a postcode spoken by the user using- the postcode grammar; means for forming a dynamic grammar for street names used as the basis for recognising the street names spoken by the user a second list of n-best recognition results; a cross matcher for producing a first match containing elements in the first and second n-best lists; a selector for selecting an element from the list if the match is positive, according to a predetermined criterion, and confirming the selection with the user; means for forming a third list of n-best recognition results from a first portion of a postcode spoken by the user; means for forming a fourth list of n-best recognition results from a town name spoken by the user; a second cross matcher for cross matching the third and fourth n-best hits to form a second match; means for passing the user from the spoken language interface to a human operator; and means for causing the speech unit to ask the user to confirm an entry in the single match; wherein, if the second match has more or less than a single entry or the user does not confirm an entry as correct, the user is passed to a human operator.

The second and fourth n-best lists are selected by first dynamically creating grammars of, respectively, street names and town names from the postcodes and first portions of postcodes which comprise the first and third n-best lists. The resultant grammars are relatively small which has the advantage that recognition accuracy is improved.

Various embodiments of the invention have the advantage of providing a multistage recognition process before a human operator becomes involved, and improve the reliability of the overall result by combing different sources of information. If the result of a cross matching between postcode and street name does not provide a result confirmed by the user, an SLI system employing aspects of the invention, in contrast to known systems, uses a spoken town name with a portion of the postcode that represents the town name. Preferably the result, if positive is then checked against the postcode and street name to provide added certainty.

Various embodiments of the invention may have the advantage of significantly improving on what is currently known, by reducing the need for human intervention. In a call centre environment, for example, this provides obvious practical benefits. Previously, address information may have been recorded on tape and sent off to be transcribed. There is a delay in subsequently accessing the information and the process is cumbersome as well as prone to errors. An electronic solution that eliminates the need for transcription of address information is very beneficial, drastically reducing the costs due to transcription, and makes the address data available in real-time. Moreover, it reduces the need for costly human operators. The more reliable the electronic solution, the less frequent will be the need for human staff to intervene.

Certain embodiments of the invention enable spoken language interfaces to be used reliably in place of human operators and reduce the need for human interface by increasing recognition accuracy.

If the first match is positive and there is only a single match, that match is selected. If there is more than one match, selection is made preferably according to the match having the highest assigned confidence level. dr

Various embodiments of the invention will now be described, by way of example only, and with reference to the accompanying drawings, in which:

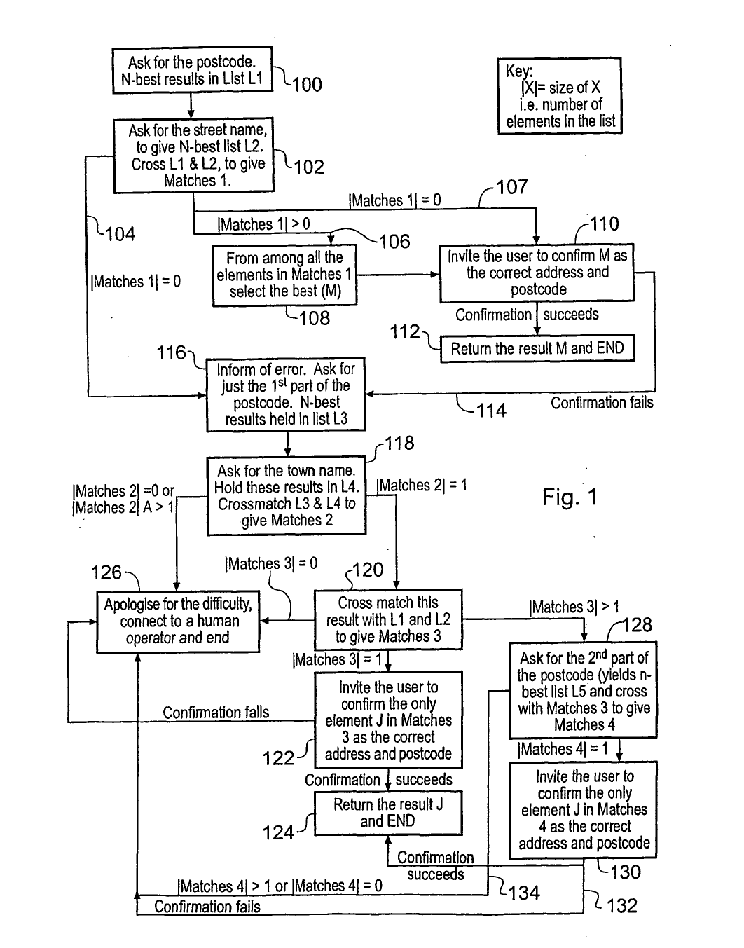

FIG. 1 is a flow chart illustrating operation of a first embodiment of the invention for recognising addresses;

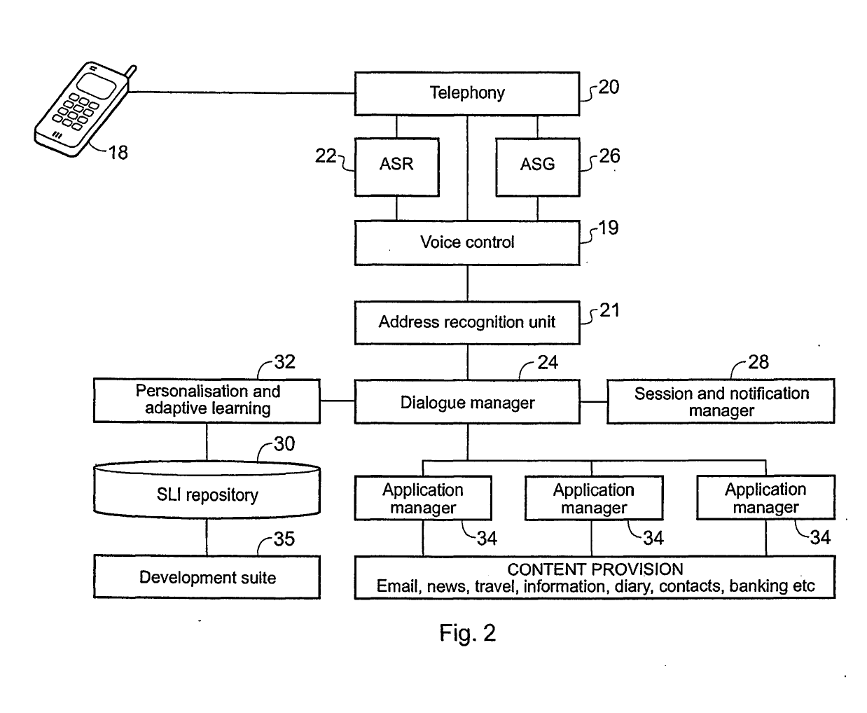

FIG. 2 is a block diagram of a spoken language interface that may be used to implement various embodiments of the invention;

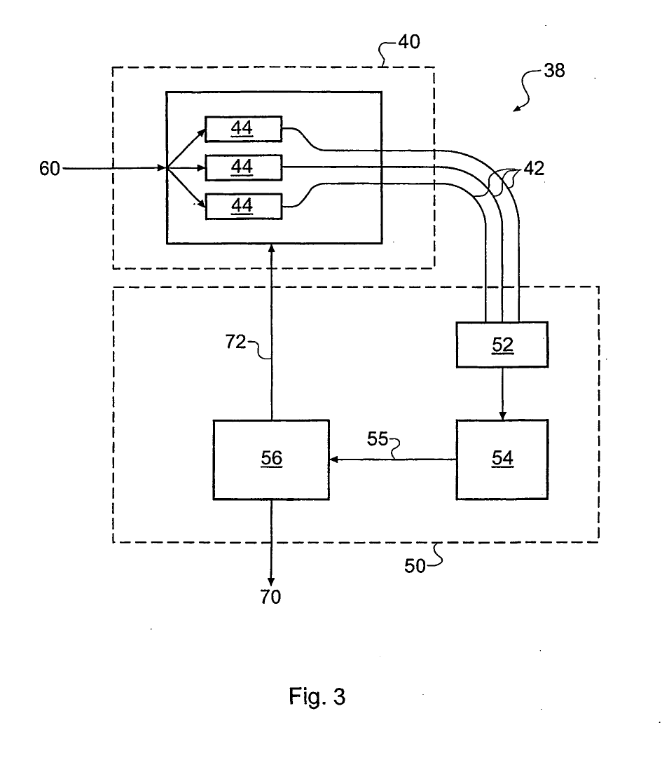

FIG. 3 shows a data selection mechanism according to an embodiment of the invention;

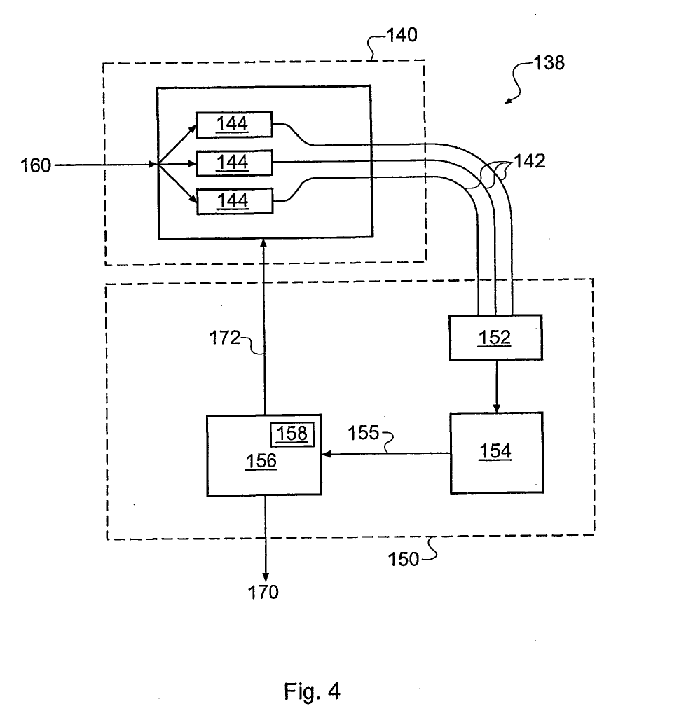

FIG. 4 shows a data selection mechanism according to another embodiment of the invention;

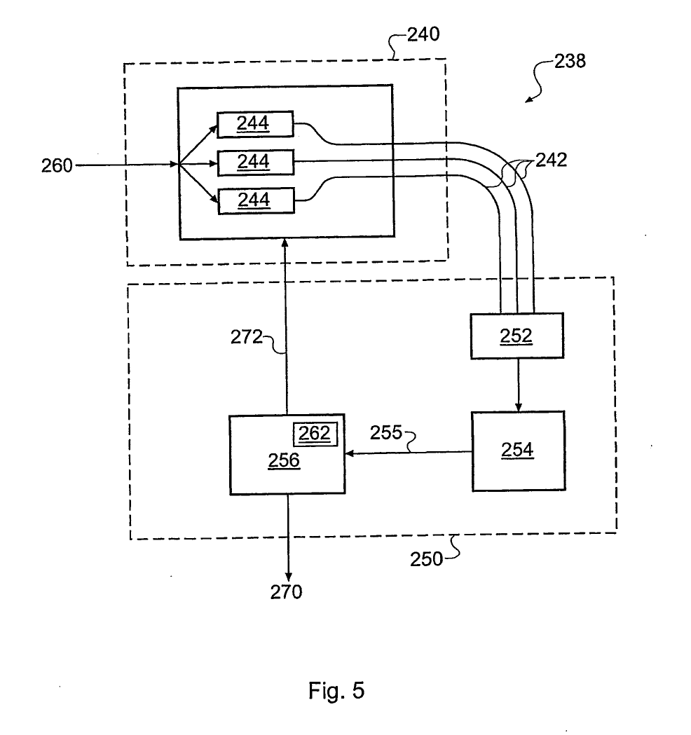

FIG. 5 shows a data selection mechanism according to a further embodiment of the invention;

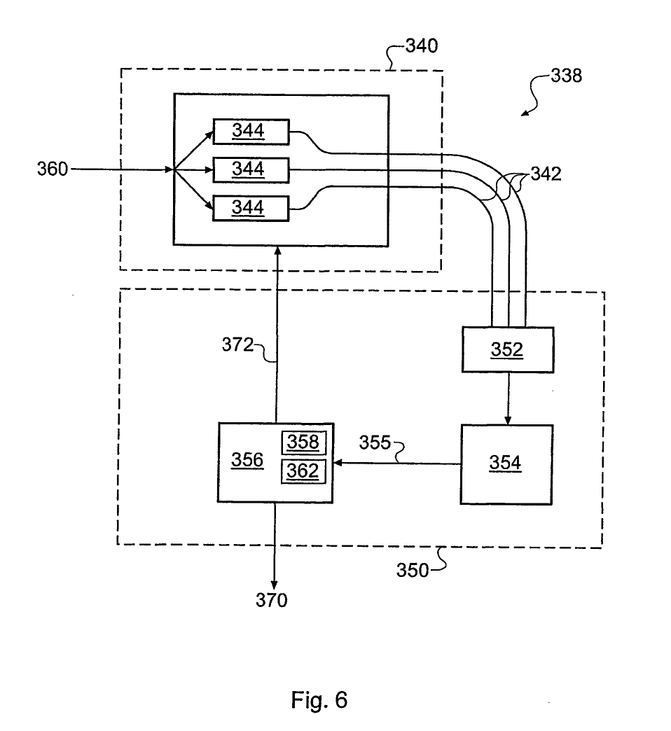

FIG. 6 shows a data selection mechanism according to yet another embodiment of the invention; and

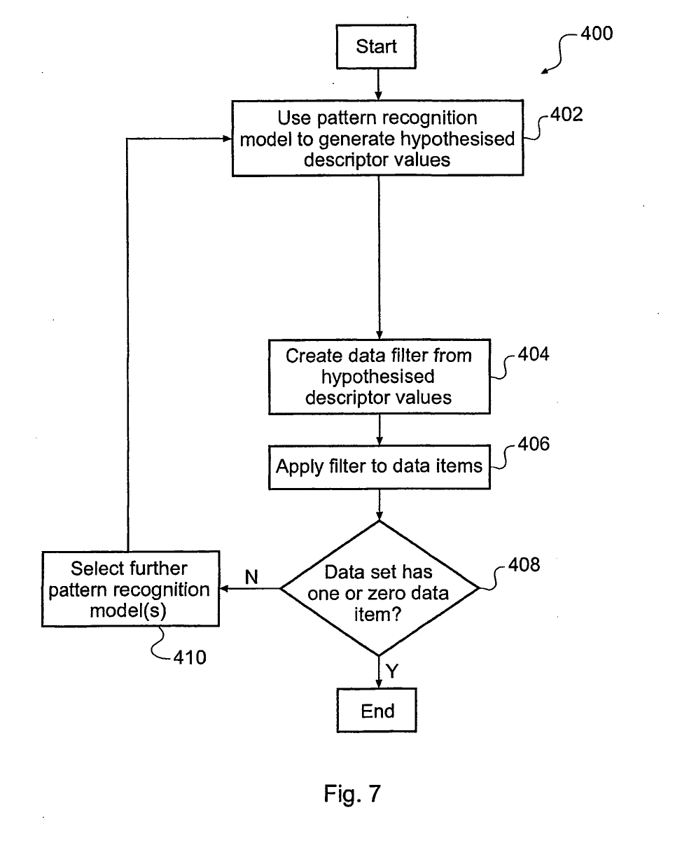

FIG. 7 shows a flowchart illustrating a method according to the invention.

The first embodiment to be described exploits constraints in the postcode structure to facilitate runtime creation of dynamic grammars for the recognition of subsequent components. These grammars are very much smaller than the entire space of UK addresses and postcodes, and consequently enable much higher recognition accuracy to be achieved. Although the description is given with respect to UK postcodes, this aspect is applicable to any address system in which the address is represented by a structured code.

Definitions

The following terms will be used in the description that follows:

Automated speech recogniser (ASR): a device capable of recognising input speech from a human and giving as output a transcript.

Recognition Accuracy: the performance indicator by which an ASR is measured—generally 100%—E % where E % is the proportion of erroneous results.

N-best list: an ASR is heavily reliant on statistical processing in order to determine its results. These results are returned in the form of a list, ranked according to the relative likelihood of each result based on the models within the ASR.

Grammar: a system of rules which define a set of expressions within some language, or fragment of a language. Grammars can be classified as either static or dynamic. Static grammars are prepared offline, and are not subject to runtime modification. Dynamic gramars, on the other hand, are typically created during runtime, from an input stream consisting of a finite number of distinct items. For example, the grammar for the names in an address book grammar might be created dynamically, during the running of that application within the SLI.

UK Postcodes are highly structured and decompose into subcategories immediately below. Here is an example postcode: CH44 3BJ

Outward Codes consist of an Area Code and a District Code.

Area Codes are either a single letter or a pair of letters. Only certain letters and pairs of letters are valid, 124 in all. Each area code is generally associated with a large town or region. Generally up to 20 smaller towns or regions are encompassed by a single area code. In the example “CH” is the area code.

District Codes follows the Area Code, and is either one or two digits. Each district code is generally associated with one main region or town. In the example, “CH 44” is the district code.

Inward Codes decompose into a Sector Code and a Walk.

Sector codes are single digits, which identify around a few dozen streets within the sector. In the example, “CH44 3” is the sector code.

Walk Codes are pair of letters. Each pairing identifies either a single address, or, more commonly, several neighbouring addresses. Thus, a complete postcode generally resolves more than one actual street address, and therefore, additional information, such as the house number, or the name of the householder, is required in order to identify an address uniquely. In the example, “BJ” is the walk code.

The following description describes an algorithm for recognising addresses based on utterances spoken by a user. The steps of the process are shown by the flow chart of FIG. 1. The algorithm may be implemented in a Spoken Language Interface such as that illustrated in FIG. 2. The SLI of FIG. 2 is a modification of an SLI disclosed in our earlier application GB 0105005.3. Various algorithms for implementing various embodiments, which may be integrated into the SLI by way of a plug-in module, can achieve a high degree of address recognition accuracy and so reduce the need for human intervention. This in turn reduces running costs, as the number of humans employed can be reduced, and increases the speed of the transaction with the user.

Referring to FIG. 1, a UK postcode grammar is first created. This is a static grammar in that it is pre-created and is not varied by the SLI in response to user utterances. The grammar may be created in BNF, a well known standard format for writing grammars, and can easily be adapted to the requirements of any proprietary format required by an Automated Speech Recognition engine (ASR).

At step 100, the SLI asks the user for their postcode. The SLI may play out recorded text or may synthesize the text. The ASR listens to the user response and creates an n-best list of recognitions, where n is a predetermined number, for example 10. This list is referred to as L1. Each entry on the list is given a confidence level which is a statistical measure of how confident the ASR is of the result being correct. It has been found that it is common for the correct utterance not to have the highest confidence level. The ASR's interpretation of the user utterance can be affected by many factors including speed and clarity of delivery and the user's accent.

The best results list L₁, is stored and at step 102 the SLI asks the user for the street name: a dynamic grammar of street names underpinning the recognition is produced, based on every result in the n-best list L1. A second n-best list L₂ of likely street names is prepared from the user utterance. Prior to doing this, the system dynamically generates a grammar for street names. In theory, the system could store a static grammar of all UK street names. However, not only would this require considerable storage space, but also recognition accuracy would be impaired as there are many identical or similar street names in the UK. This greatly increases the likelihood of confusion. The dynamic grammar of street names is constructed by reference to the area, district and sector codes of the postcodes in the candidate list L₁, prepared from the first user utterance. For each sector level code, up to a few dozen street names can be covered. The combined list of all these names, for each of the n-best hypotheses constitutes the dynamic grammar for the street name recognition 102. This grammar is used to underpin speech recognition in the next stage. Within the SLI, the street names are stored in a database with their related sector codes. The relevant street names are simply read out from the database and into a random access memory of the ASR to form the dynamic grammar of street names.

In construction of the dynamic grammar, the aim is a grammar which offers high recognition accuracy.

Once the list L₂ has been generated, the lists L₁ and L₂ are cross matched to collect the consistent matches between the lists. Each result in the list L₂ has the authentic full postcode code associated with it, since, given the street name, the postcode follows, by a process of lookup. In the event of a streetname's having more than one postcode associated with it, we can immediately eliminate as implausible any postcodes which are not present in the list L1. Each of these candidate postcodes are compared with the original n-best list of possibilities L₁. There are three possibilities:

1. There are no matches, (path 104) in which case a recovery process is begun;

2. There is one unique match (107). This value is proposed by the SLI to the user at step 110. If the user confirms the match as correct, the value is returned to the system and the process ends at step 112. If the user denies the result, the recovery process is begun, (step 116).

3. Finally, if the match provides several possibilities (step 106), the system examines the combined confidence of each postcode and street name pairing at step 108 to resolve the ambiguity. The highest scoring pair is selected and returned to the user who is invited at 110 to confirm or deny that postcode. If confirmed, the result is returned at 112 and the procedure ends. If denied, the recovery process is entered at 114.

The recovery process commences with the user being informed of the error at 116. This may be by a pre-recorded utterance which is played out to the user. The utterance may apologise to the user for the confusion and will ask them for just the outward code; that is the area code plus the district code. In our earlier example this would be CH 44. As postcodes are hierarchical, the recovery procedure is begun at the most general level to exploit the hierarchical nature of these constraints. It is undesirable to go through the recovery procedure more than once and so the recovery procedure explicitly asks the user for more detailed information. At this stage, what matters to users most is getting the information right. Asking for the outward code has two advantages. First, the area code defines a rather arbitrary region associated with the names of several towns and similar regions. The user can therefore be prompted for the town name to help confirm the area code result. Secondly, every other detail in the address depends on this detail being correct. If the system is looking in the wrong place, it will not find the result. From the point of view of the interaction with the human user, it is preferable to ask the user for new information rather than asking them to repeat details they have already given.

Thus, at step 116, a third list L₃ is made of the area codes and at step 118 the user is asked for the name of the town. As before, the area codes are provided from a static grammar but the town list grammar is generated dynamically for each of the n-best lists of area codes L₃. Each area code is associated with approximately 20 towns and so if n=10, the town list grammar will consist of approximately 200 towns. In response to the user's utterance of the town, the system creates a further list L₄. The lists L₃ and L₄ are then cross matched to form a second match, match 2. This process of cross-matching works as follows: each town name has a return value which is an area level code. We simply examine each of these return values, and select those which have match in list L3. This yields Match 2

If the result of the cross match of lists L₃ and L₄ to form match 2 is 0 or >1, the process defaults to step 126 and connects to a human operator.

If this match 2 contains a single result, there is a high confidence that the outward code is correct and the address now needs to be validated. First, the result is cross matched at step 120 with each of lists L₁ and L₂ to give a result match 3. This crossmatching operates across 2 pairs of separate lists, viz., L1 (postcodes), & Matches 2) (Area code & town); and L2 (streetnames) with Matches 2. We hold all the matches together in a single list Matches3. If, this Matches3 contains a single result, then at step 122 the user is invited to confirm that the single result of the match is the correct postcode and address. If the user confirms, the result is returned at 124 and the process stops. If the user denies, the system defaults to human operator in which case the SLI plays out an apology to the user at step 126, connects to a human operator and terminates the process.

If the result of the cross match which results in match 3 at step 120 is 0, the process defaults straight to step 126 and transfers to a human operator.

If the list matches3 obtained at step 120 returns more than one result, the user, at step 128 is asked for the 2^{nd} part of the postcode, the inward code. A further n-best list L₅ is created. This is crossmatched with the members of matches 3 to give matches 4. If this produces a single result, the user is asked, at step 130, to confirm the single result of match 4 as the correct address and postcode. If he so confirms, the result is returned and the process stops. If he denies the result, at 132, the process goes to step 126 and the user is transferred to a human operator. Similarly, if the result of match 4 is either an empty list or one with multiple members, the process, at 134, goes to step 126 and a human operator intervenes.

In the preceding discussion, it was mentioned that confidence measures can be combined, in order to discriminate between multiple cross matches. A cross match consists of one element from each of the lists involved in the crossmatching. To evaluate the combined confidence, we compute the average of the confidence scores in each cross match. Generally, we include empirically validated weighting factors to modify the significance of each contributor to the final overall score of each multiple. This is to reflect the fact that the confidence measures in each n-best list are not strictly comparable. We collect field data about, for example, relative error rates between each of the n-best lists. This information is helpful in selecting weights. Candidate weights can be further ‘tuned’ by empirical measures of accuracy achieved when those values are used. In the event that insufficient data is available to determine the weighting factors, simple averaging of the confidence scores can be used as by default.

In case of a two or more equally high score, the system immediately commences recovery, or if it is in recovery already, connects to a human operator. (Step 126).

A Grammar for UK Postcodes.

The simple BNF grammar below defines the major constraints, which operate for UK postcodes. In fact not every possible postcode is currently assigned, and some become re-assigned from time to time. Nevertheless, such a grammar specifies the minimum conditions for a sequence of symbols being a legitimate postcode.

The <space> separates the OUTWARD and INWARD portions of the postcode. The OUTWARD portion identifies a postcode district. The UK is divided into about 2700 of these. The INWARD portion identifies at the “sector” level one of the 9000 sectors into which district postcodes are divided. The last 2 letters in the postcode identify a unit postcode.

NB: Certain inner London postcodes are exceptional, in that the digit portion of the Outward code can be followed by an additional letter, eg. SW1E 5JD. These can easily be accommodated by adding a few rules to the grammar, but are omitted in the example, for simplicity. This has no material impact on the invention described since the grammar is provided mainly for illustration.

Postcode ::= pattern1 | pattern2 | pattern3 | pattern4
Pattern1 ::= αδ <space> σωω
Pattern2 ::= αδδ <space> σωω
Pattern3 ::= βδ <space> σωω
Pattern4 ::= βδδ <space> σωω
α ::= N | W | E | S | L | B | G | M
β ::= AB | AL | B | BA | BB | BD | BH | BL | BN | BR | BS |
BT | CA | CB | CF | CH | CM | CO | CR | CT | CV | CW | DA |
DD | DE | DG | DH | DL | DN | DT | DY | E | HA | HD | HG |
HP | HR | HS | HU | HX | IG | IM | IP | IV | JE | KA |
KT | KW | KY | L | LA | LD | LE | LL | LN | LS | LU | M |
ME | MK | ML | N | NE | NG | PO | PR | RG | RH | RM | S |
SA | SE | SG | Of | SL | SM | SN | SO | SP | SR | SS | ST |
SW | SY | TA | TD | TF | TN | TQ | TR | TS | TW | US | W |
WA | WC |
δ ::= 0 | 1 | 2 | 3 | 4 | 5 | 6 | 7 | 8 | 9 |
σ ::= 0 | 1 | 2 | 3 | 4 | 5 | 6 | 7 | 8 | 9 |
ω ::= A | B | D | E | F | G | H | J | L | N | P | Q | R | S |
T | U | W | X | Y | Z

Example List of Street Names for Area, District, Sector Code

For the sector code SW1E 5, the following street names are covered:

Allington Street, Bressenden Place, Palace Street, Stag Place, Victoria Arcade, Victoria Street, Warwick Row.

Example list of possible towns for Area Code For the area code AB, the following towns are covered:

Aberdeen, Aberlour, Aboyne, Alford, Ballater, Ballindalloch, Banchory, Banff, Buckie, Ellon, Fraserburgh, Huntly, Insch, Inverurie, Keith, Laurencekirk, Macduff, Milltimber, Peterculter, Peterhead, Stonehaven, Strathdon, Turriff, Westhill.

Worked Example

1) Actual Postcode: N4 3 AB In response to a system prompt, the user says “N4 3 AB.” n-best list L1 is returned.

L1=(M4 3 AW confidence=0.7)

(N4 3 AB confidence=0.6)

(N4 3 BU confidence=0.5)

For each element in this list, the possible street names are determined by querying a database with the corresponding sector code. So:

M4 3:

Arndale Centre

Hanging Ditch

Withy Grove.

N4 3:

Albert Road

Almington Street

Athelstane Mews

Biggerstaff Street

Birnam Road

Bracey Mews

Bracey Street

Charteris Road

Clifton Court

Clifton Terrace

Coleridge Road

Corbyn Street

Dulas Street

Ennis Road (N4 3 HD)

Everleigh Street

Evershot Road (N4 3 BU)

Fonthill Road

Goodwin Street

Hanley Road

Hatley Road

Leeds Place

Lennox Road

Lorne Road

Marquis Road

Marriott Road

Montem Street

Montis Street

Moray Road

Morris Place

Osborne Road

Oxford Road

Perth Road

Pine Grove

Playford Road

Pooles Park

Regina Road

Serle Place

Seven Sisters Road

Six Acres Estate

Stapleton Hall Road

Stonenest Street

Stroud Green Road

Thorpedale Road

Tollington Park

Tollington Place

Turle Road

Turlewray Close

Upper Tollington Park

Victoria Road

Wells Terrace

Woodfall Road

Woodstock Road

Wray Crescent

Yonge Park

Notice that in this example, in the n-best list L1, the results in 2^{nd} and 3^{rd} position happen to postulate the same list of street names for inclusion in the dynamic grammar for street name recognition.

The user is next asked to say the streetname. The grammar underpinning this recognition is a union of all the street names listed above. The user says: “Evershot Road.” Now for this street name, as for every street name, we know the postcode, by the simple means of a database lookup. (For simplicity, we have omitted to lookup the postcodes for most of the street names—however it is trivial to do this). For Evershot Road, the postcode is N4 3 BU.

The system produces a second n-best list L2:

L2={Evershot Road [N4 3 BU] confidence=0.7; Ennis Road [N4 3 HD] confidence=0.5}

For each result in L2, we now consider whether the postcode with which it is associated by lookup is actually present in the n-best list L1. In our example, it is, and therefore we offer “N4 3 BU” to the user to be confirmed or denied. Since this is indeed the correct answer, in this example, the user confirms and the algorithm terminates.

Referring now to FIG. 2, an example of Spoken Language Interface is shown.

The architecture illustrated can support run time loading. This means that the system can operate all day every day and can switch in new applications and new versions of applications without shutting down the voice subsystem. Equally, new dialogue and workflow structures or new versions of the same can be loaded without shutting down the voice subsystem. Multiple versions of the same applications can be run. The system includes adaptive learning which enables it to learn how best to serve users on global (all users), single or collective (e.g. demographic groups) user basis. This tailoring can also be provided on a per application basis. The voice subsystem provides the hooks that feed data to the adaptive learning engine and permit the engine to change the interfaces behaviour for a given user.

The key to the run time loading, adapting learning and many other advantageous features is the ability to generate new grammars and prompts on the fly and in real time which are tailored to that user with the aim of improving accuracy, performance and quality of user interaction experience.

The system schematically outlined in FIG. 2 is intended for communication with applications via mobile, satellite, or landline telephone. However, it is not limited to such systems and is applicable to any system where a user interacts with a computer system, whether it is direct or via a remote link. In the example shown this is via a mobile telephone 18 but any other voice telecommunications device such as a conventional telephone can be utilised. Calls to the system are handled by a telephony unit 20. Connected to the telephony unit are a Voice Controller 19, an Automatic Speech Recognition System (ASR) 22 and an Automatic Speech Generation System (ASG) 26. The ASR 22 and ASG systems are each connected to the voice controller 19. A dialogue manager 24 is connected to the voice controller 19 and also to a Spoken Language Interface (SLI) repository 30, a personalisation and adaptive learning unit 32 which is also attached to the SLI repository 30, and a session and notification manager 28. The Dialogue Manager is also connect to a plurality of Application Managers (AM) 34 each of which is connected to an application which may be content provision external to the system. In the example shown, the content layer includes e-mail, news, travel, information, diary, banking etc. The nature of the content provided is not important to the principles of the invention.

The SLI repository is also connected to a development suite 35. Connected between the voice control unit and the dialogue manager is an address recognition unit 21. This is a plug-in unit which can perform an address recognition method, such as, for example, that described with respect to FIG. 1 above. The address recognition unit controls the ASR 22 and ASG 26 to generate the correct prompts for user's and to interpret user utterances. Moreover, it can utilise postcode and address data together with static grammars for postcode and area codes which are stored in the repository 30.

The system is task orientated rather than menu driven. A task orientated system is one which is conversational or language oriented and provides an intuitive style of interaction for the user modelling the user's own style of speaking rather than asking a series of questions requiring answers in a menu driving fashion. Menu based structures are frustrating for users in a mobile and/or aural environment. Limitations in human short-term memory mean that typically only four or five options can be remembered at one time. “Barge-In”, the ability to interrupt a menu prompt, goes some way to overcoming this but even so, waiting for long option lists and working through multi-level menu structures is tedious. The system to be described allows users to work in a natural a task focussed manner. Thus, if the task is to book a flight to JFK Airport, rather than proceeding through a series of menu options, the user simply says: “I want to book a flight to JFK”. The system accomplishes all the associated sub tasks, such as booking the flight and making an entry in the users diary for example. Where the user has needs to specify additional information this is gathered in a conversational manner, which the user is able to direct.

The system can adapt to individual user requirements and habits. This can be at interface level, for example, by the continual refinement of dialogue structure to maximise accuracy and ease of use, and at the application level, for example, by remembering that a given user always sends flows to their partner on a given date.

The various functional components are briefly described as follows:

Voice Control 19

This allows the system to be independent of the ASR 22 and TTS 26 by providing an interface to either proprietary or non-proprietary speech recognition, text to speech and telephony components. The TTS may be replaced by, or supplemented by, recorded voice. The voice control also provides for logging and assessing call quality. The voice control will optimise the performance of the ASR.

Spoken Language Interface Repository 30

In contrast to other systems, grammars, that is constructs and user utterances for which the system listens, prompts and workflow descriptors are stored as data in a database rather than written in time consuming ASR/TTS specific scripts. As a result, multiple languages can be readily supported with greatly reduced development time, a multi-user development environment is facilitated and the database can be updated at anytime to reflect new or updated applications without taking the system down. The data is stored in a notation independent form. The data is converted or complied between the repository and the voice control to the optimal notation for the ASR being used. This enables the system to be ASR independent. The database of postcodes, town and street addresses, for example, are stored in the SLI repository. A static postcode and a static area code grammar can also be stored. The street name and town name dynamic grammars can be formed by retrieving street and town names from the repository which fall within the parameters of the postcodes or area codes of the lists L₁ and L₃ respectively.

ASR & ASG (Voice Engine) 22, 26

The voice engine is effectively dumb as all control comes from the dialogue manager via the voice control.

Dialogue Manager 24

The dialogue manager controls the dialogue across multiple voice servers and other interactive servers (eg WAP, Web, etc). As well as controlling dialogue flow it controls the steps required for a user to complete a task through mixed initiative—by permitting the user to change initiative with respect to specifying a data element (e.g. destination city for travel). The Dialog Manager may support comprehensive mixed initiative, allowing the user to change topic of conversation, across multiple applications while maintaining state representations where the user left off in the many domain specific conversations. Currently, as initiative is changed across two applications, state of conversation is maintained. Within the system, the dialogue manager controls the workflow. It is also able to dynamically weight the user's language model by adaptively controlling the probabilities associated with the likely speaking style that the individual user employs dialogue structures in real-time, this is the chief responsibility the Adaptive Learning Engine and the current state of the conversation as a function of the current state of the conversation e user with the user. The method by which the adaptive learning agent was conceived, is to collect user speaking data from call data records. This data, collected from a large domain of callers (thousands) provides the general profile of language usage across the population of speakers. This profile, or mean language model probabilities to improve ASR accuracy. Within a conversation, the individual user's profile is generated and adaptively tuned across the user's subsequent calls. Early in the process, key linguistic cues are monitored, and based on individual user modelling, the elicitation of a particular language utterance dynamically invokes the modified language model profile tailored to the user, thereby adaptively tuning the user's language model profile and individual increasing the ASR accuracy for that user.

Additionally, the dialogue manager includes a personalisation engine. Given the user demographics (age, sex, dialect) a specific personality tuned to user characteristics for that user's demographic group is invoked.

The dialogue manager also allows dialogue structures and applications to be updated or added without shutting the system down. It enables users to move easily between contexts, for example from flight booking to calendar etc, hang up and resume conversation at any point; specify information either step-by-step or in one complex sentence, cut-in and direct the conversation or pause the conversation temporarily.

Telephony

The telephony component includes the physical telephony interface and the software API that controls it. The physical interface controls inbound and outbound calls, handles conferencing, and other telephony related functionality.

Session and Notification Management 28

The Session Manager initiates and maintains user and application sessions. These are persistent in the event of a voluntary or involuntary disconnection. They can reinstate the call at the position it had reached in the system at any time within a given period, for example 24 hours. A major problem in achieving this level of session storage and retrieval relates to retrieving a session in which a conversation is stored with either a dialogue structure, workflow structure or an application manager has been upgraded. In one embodiment this problem is overcome through versioning of dialogue structures, workflow structures and application managers. The system maintains a count of active sessions for each version and only returns old versions once the versions count reaches zero. An alternative which may be implemented, requires new versions of dialogue structures, workflow structures and application managers to supply upgrade agents. These agents are invoked whenever by the session manager whenever it encounters old versions in the stored session. A log is kept by the system of the most recent version number. It may be beneficial to implement a combination of these solutions the former for dialogue structures and workflow structures and the latter for application managers.

The notification manager brings events to a user's attention, such as the movement of a share price by a predefined margin. This can be accomplished while the users are offline through interaction with the dialogue manager or offline. Offline notification is achieved either by the system calling the user and initiating an online session of through other media channels, for example, SMS, Pager, fax, email or other device.

Application Managers

Application Managers (AM) are components that provide the interface between the SLI and one or more of its content suppliers (i.e. other systems, services or applications). Each application manager (there is one for every content supplier) exposes a set of functions to the dialogue manager to allow business transactions to be realised (e.g. GetEmail( ), SendEmail( ), BookFlight( ), GetNewsItem( ), etc.). Functions require the DM to pass the complete set of parameters required to complete the transaction. The AM returns the successful result or an error code to be handled in a predetermined fashion by the DM.

An AM is also responsible for handling some stateful information. For example, User A has been passed the first 5 unread emails. Additionally, it stores information relevant to a current user task. For example, flight booking details. It is able to facilitate user access to secure systems, such as banking, email or other. It can also deal with offline events, such as email arriving while a user is offline or notification from a flight reservation system that a booking has been confirmed. In these instances the AM's role is to pass the information to the Notification Manager.

An AM also exposes functions to other devices or channels, such as web, WAP, etc. This facilitates the multi channel conversation discussed earlier.

AMs are able to communicate with each other to facilitate aggregation of tasks. For example, booking a flight primarily would involve a flight booking AM, but this would directly utilise a Calender AM in order to enter flight times into a users Calendar.

AMs are discrete components built, for example, as enterprise Java Beans (EJBs) they can be added or updated while the system is live.

Transaction & Message Broker 142

The Transaction and Message Broker records every logical transaction, identifies revenue-generating transactions, routes messages and facilitates system recovery.

Adaptive Learning & Personalisation 32; 148, 150

Spoken conversational language reflects quite a bit of a user's psychology, socio-economic background, and dialect and speech style. The reason an SLI is a challenge is due to these confounding factors. Various embodiments of the invention provide a method of modelling these features and then tuning the system to effectively listen out for the most likely occurring features. Before discussing in detail the complexity of encoding this knowledge, it is noted that a very large vocabulary of phrases encompassing all dialectic and speech style (verbose, terse or declarative) results in a complex listening test for any recogniser. User profiling, in part, solves the problem of recognition accuracy by tuning the recogniser to listen out for only the likely occurring subset of utterance in a large domain of options.

The adaptive learning technique is a stochastic (statistical) process which first models which types, dialects and styles the entire user base of users employ. By monitoring the Spoken Language of many hundreds of calls, a profile is created by counting the language mostly utilised across the population and profiles less likely occurrences. Indeed, the less likely occurring utterances, or those that do not get used at all, could be deleted to improve accuracy. But then, a new user who might employ the deleted phrase, not yet observed, could come along and he would have a dissatisfying experience and a system tuned for the average user would not work well for him. A more powerful technique is to profile individual user preferences early on in the transaction, and simply amplify those sets of utterances over those utterances less likely to be employed. The general data of the masses is used initially to set a set of tuning parameters and during a new phone call, individual stylistic cues are monitored, such as phrase usage and the model is immediately adapted to suit that caller. It is true, those that use the least likely utterances across the mass, may initially be asked to report what they have said, after which the cue re-assigns the probabilities for the entire vocabulary.

The approach, then, embodies statistical modelling across an entire population of users. The stochastic nature of the approach occurs, when new observations are made across the average mass, and language modelling weights are adaptively assigned to tune the recogniser.

Help Assistant & Interactive Training

The Help Assistant & Interactive Training component allows users to receive real-time interactive assistance and training. The component provides for simultaneous, multi channel conversation (i.e. the user can talk through a voice interface and at the same time see visual representation of their interaction through another device, such as the web).

Databases

The system uses a commercially available database such as Oracle 8I from Oracle Corp.

Central Directory

The Central Directory stores information on users, available applications, available devices, locations of servers and other directory type information.

System Administration—Infrastructure

The System Administration—applications, provides centralised, web-based functionality to administer the custom build components of the system (e.g. Application Managers, Content Negotiators, etc).

Rather than having to laboriously code likely occurring user responses in a cumbersome grammar (e.g. BNF grammar—Backus Naur Format) resulting in time consuming detailed syntactic specification, the development suite provides an intuitive hierarchical, graphical display of language, reducing the modelling act to reactively uncover the precise utterance by the coding act to a simple entry of a data string. The development suite enables a Rapid Application Development (RAD) tool that combines language modelling with business process design (workflow).

It will be appreciated from the foregoing that a method and apparatus has been described in connection with various embodiments of the invention which allow for, for example, automated address recognition using a spoken language interface. Although such a system provides for human intervention, it can provide a high degree of recognition accuracy minimising the need for that human intervention.

FIG. 3 shows a data selection mechanism 38 according to an embodiment of the invention. The data selection mechanism 38 comprises a pattern matching mechanism 40 operably coupled to a filter mechanism 50. The pattern matching mechanism 40 is operable to apply one or more pattern recognition model 44 to user-generated input 60 to generate zero or more hypothesised descriptor values 42 for each pattern recognition model 44. Hypothesised descriptor values 42 may optionally be associated with probabilities/confidences/distance measures.

The filter mechanism 50 comprises a filter creation mechanism 52, a database 54 of data items and dynamic model selection/creation mechanism 56. The dynamic model selection/creation mechanism 56 includes a hypothesis history repository that stores sets of descriptor hypotheses that have previously been generated. The filter creation mechanism 52 is operable to analyse the hypothesised descriptor values 42 generated by the pattern recognition models 44, and to create a data filter from the hypothesised descriptor values 42 with sufficiently high confidence or probability or low enough distance measure. The data filter is then submitted to the database 54 as a database query. The database runs the query and returns a filtered data set 55 of candidate data items to the dynamic model selection/creation mechanism 56.

The dynamic model selection/creation mechanism 56 then analyses the filtered data set 55.

If the filtered data set 55 contains only a single data item 70, the single data item 70 is output from the data selection mechanism 38.

If the filtered data set 55 contains zero data items, the dynamic model selection/creation mechanism 56 generates an error. Errors may be brought to the attention of a human operator or give rise to suspension of data selection mechanism operation.

If the filtered data set 55 contains more than one data item and there remain unconsidered descriptors, the dynamic model selection/creation mechanism 56 selects and/or creates one or more pattern recognition models 72 in dependence on the filtered data set 55, the next descriptor to consider according to some predetermined ordering and optionally the previous descriptor hypotheses stored in the hypothesis repository. The pattern recognition models 72 are then provided to the pattern matching mechanism 40 for applying to further user-generated input 60. In one embodiment, selection and/or generation of pattern recognition models 72 is dependent upon the hypothesised descriptor values 42 and the previous descriptor hypotheses stored in the hypothesis repository, the pattern recognition models 72 having entries weighted according to the number of descriptor hypotheses with which they are consistent. Where all the descriptors have been considered, a ranked list of descriptors or filtered data items are output.

FIG. 4 shows a data selection mechanism 138 according to another embodiment of the invention. The data selection mechanism 138 comprises a pattern matching mechanism 140 operably coupled to a filter mechanism 150. The pattern matching mechanism 140 is operable to apply one or more pattern recognition models 144 to user-generated input 160 to generate zero or more hypothesised descriptor value 142 for each pattern recognition model 144. Hypothesised descriptor values 142 may optionally be associated with probabilities/confidences/distance measures.

The filter mechanism 150 comprises a filter creation mechanism 152, a database 154 of data items and dynamic model selection/creation mechanism 156. The filter creation mechanism 152 is operable to analyse the hypothesised descriptor values 142 generated by the pattern recognition models 144 to create a data filter from the hypothesised descriptor values 142 with sufficiently high confidence or probability or low enough distance measure. The data filter is then submitted to the database 154 as a database query. The database runs the query and returns a filtered data set 155 of candidate data items to the dynamic model selection/creation mechanism 156.

The dynamic model selection/creation mechanism 156 comprises a dynamic ordering mechanism 158 and includes a hypothesis history repository that stores a set of descriptor hypotheses that have been previously generated. Dynamic model selection/creation mechanism 156 analyses the filtered data set 155.

If the filtered data set 155 contains only a single data item 170, the single data item 170 is output from the data selection mechanism 138.

If the filtered data set 155 contains zero data items, the dynamic model selection/creation mechanism 156 generates an error. Errors may be brought to the attention of a human operator or give rise to suspension of data selection mechanism operation.

If the filtered data set 155 contains more than one data item and there remain unconsidered descriptors, dynamic ordering mechanism 158 analyses the filtered data set 155 in order to identify the descriptor which is likely to produce a minimum sized data set, maximum information gain or maximum reduction in data uncertainty following a further recognition by the pattern matching mechanism 140.

The dynamic model selection/creation mechanism 156 selects and/or creates one or more pattern recognition models 172 in dependence on the filtered data set 55, the descriptor chosen by the dynamic ordering mechanism and optionally the previous descriptor hypotheses stored in the hypothesis repository. The pattern recognition models 172 are then provided to the pattern matching mechanism 140 to apply to further user-generated input 160. In one embodiment, hypotheses stored in the hypothesis history repository may be pruned by considering constraint violations and/or descriptor mismatches. Where all the descriptors have been considered, a ranked list of descriptors or filtered data items are output.

FIG. 5 shows a data selection mechanism 238 according to a further embodiment of the invention. The data selection mechanism 238 comprises a pattern matching mechanism 240 operably coupled to a filter mechanism 250. The pattern matching mechanism 240 is operable to apply one or more pattern recognition models 244 to user-generated input 260 to generate zero or more hypothesised descriptor value 242 for each pattern recognition model 244. Hypothesised descriptor values 242 may optionally be associated with probabilities/confidences/distance measures.

The filter mechanism 250 comprises a filter creation mechanism 252, a database 254 of data items and dynamic model selection/creation mechanism 256. The dynamic model selection/creation mechanism 256 includes a hypothesis history repository that stores a set of descriptor hypotheses that have previously been generated. The filter creation mechanism 252 is operable to analyse the hypothesised descriptor values 242 generated by the pattern recognition models 244, and to create a data filter from the hypothesised descriptor values 242 with sufficiently high confidence or probability or low enough distance measure. The data filter is then submitted to the database 254 as a database query. The database runs the query and returns a filtered data set 255 of candidate data items to the dynamic model selection/creation mechanism 256.

The dynamic model selection/creation mechanism 256 comprises an error recovery mechanism 262. Dynamic model selection/creation mechanism 256 analyses the filtered data set 255.

If the filtered data set 255 contains only a single data item 270, the single data item 270 is output from the data selection mechanism 238.

If the filtered data set 255 contains more than one data item and there remain unconsidered descriptors, the dynamic model selection/creation mechanism 256 selects and/or creates one or more pattern recognition models 272 in dependence on the filtered data set 255, the next descriptor to consider according to some predetermined ordering and optionally the previous descriptor hypotheses stored in the hypothesis repository, and provides them to the pattern matching mechanism 240 to apply to further user-generated input 260.

If the filtered data set 255 contains zero data items, the error recovery mechanism 262 initiates an error recovery operation. The error recovery mechanism 262 can invoke one or more of the following strategies:

a) Attempt to determine which of the sets of descriptor hypotheses stored in the hypothesis history repository are most likely to be incorrect (i.e. do not contain a hypothesis corresponding to the descriptor value that the user generated input was intended to imply), for example by consideration of the number of remaining data items in filtered data sets that are consistent with k−1 (or k−2, k−3 in the case of multiple erroneous descriptor hypotheses), and reanalyse the user generated input using a modified and dynamically generated pattern recognition model or elicit further user-generated input 260 for the erroneous descriptor or descriptors.

b) Continue considering new descriptors, while deriving filtered data sets that correspond with k−1 of the k descriptors for which hypotheses exist in the hypothesis history repository.

c) If some pattern recognition hypotheses were not used in previous filtering steps, by virtue of their low ranking in terms of confidence, probability or distance metric, then consider more hypotheses in order to achieve a data set with one or more data items.

FIG. 6 shows a data selection mechanism 338 according to yet another embodiment of the invention. This embodiment incorporates both an error recovery mechanism 362 and a dynamic ordering mechanism 358. These operate in a similar manner to their counterparts as described above.

FIG. 7 shows a flowchart 400 illustrating a method according to the invention. At step 402 one or more pattern recognition model is applied to user-generated input to generate hypothesised descriptor values. Subsequently, in step 404 a data filter is created using the hypothesised descriptor values. The data filter is then applied to a set of data items (step 406) to provide a filtered data set. A test is performed at step 408 to determine whether the filtered data set contains either a single or zero data items. If more than one data item is in the filtered data set, further pattern recognition models are selected and/or created based upon hypothesised descriptor values at step 410. The further pattern recognition models are then fed back to be used for further pattern recognition. This provides an iterative method for selecting a single data item from a plurality of data items.

Another embodiment of the invention provides an e-mail address recognition mechanism. This embodiment, and any variants of it, may be provided by the data selection mechanism illustrated in FIGS. 3 to 6 and/or by the method illustrated in FIG. 7. The need to recognise Email addresses as part of a spoken dialogue poses particular problems. Where addresses are already known to the system, then straightforward strategies for specifying them are available, such as replying to a previous mail or by use of the addressee's name (or combinations of personal details in a multi channel disambiguation approach using descriptors such as first and last name, department, telephone number, extension etc.). However, if the need arises to send a mail to an address that is unknown to the system, then there is a requirement for an alternative approach. This embodiment of the invention addresses this problem.

The number of dialogue turns required to complete an action (such as specifying an email address) can be used as a measure of the transaction efficiency of a system. The task of recognising an email address could be attempted in a single turn by allowing the user to specify the whole address in a single utterance, but the difficulty of the task may mean that a large number of filtering steps are required before the correct address is arrived at. On the other hand, the task may be split into separate recognition steps in a multi-channel disambiguation approach using different parts of the email address as descriptors, such as the first part of the email address (the part before the @ symbol), domain name (the part after the @ symbol) and top-level domain (TLD—e.g. “.co.uk”, “.com” etc). While this will tend to increase the minimum number of dialogue turns required to specify an email address, it can decrease the average number of dialogue turns required by constraining the task sufficiently to allow more accurate recognition.

Systems can feel more natural to a user when the human-machine dialogue strategy is similar to that employed by the user in human-human dialogue. So different approaches to the recognition task will effect how natural the system feels to the user. There is a trade off between a natural dialogue strategy that may hold more intuitive appeal with the user but has a lower success rate, and a strategy that may at first seem quite unnatural to a user, but that attains greater recognition/identification success. Of course, the recognition/identification success of a system also impinges on the perceived naturalness: for example, a system that asks all the right questions will not be perceived as natural if it cannot reliably interpret the responses it receives.

In considering the following approaches to email address recognition it is important to bear in mind these issues. Ideally the system should achieve a high recognition/identification success rate and at the same time feel natural to the user, but this desire must be mitigated by the realities of the technology and the difficulty of the task. It should be borne in mind that users happily adapt to systems that help them reliably achieve their aims.

Recognition Methods

Direct Recognition

Email addresses conform to a certain structure:

X@Y.Z

Where:

X and Y are strings of letters, numbers and symbols. (which?)

Z is one of a few top-level domain (TLD) name suffixes, e.g. “com”, “co.uk” etc . . .

Strings X and Y are particularly difficult to recognise accurately due to the lack of constraint on their form, and the ambiguity in the way they may be enunciated.

The following are realistic email addresses; each is associated with the way in which it is likely to be enunciated:

spjerch@ypt.pcl.ac.uk
“s p j e r c h @ y p t dot p c l dot ac dot u k”
phick@liap.ac.uk
“p hick @ l i a p dot a c dot u k”
bob.croutchley@Logo-Tech.com
“bob dot croutchley @ logo dash tech dot com”
bkentucky@mitchellhouse.co.uk
“b kentucky @ Mitchell house dot co dot u k
b_crick99@aol.com
“b underscore crick ninety nine @ a o l dot com”

While this is not a representative sample of email addresses, they do illustrate some patterns. The strings referred to above as X and Y appear to consist of arbitrary combinations of names, words, letters, numbers and symbols (dash, underscore and dot). A grammar could be developed that covered a large proportion of such utterances, but the perplexity (which is a measure of the number of words that the recogniser must consider at any one time) would be very large. Tests using a commercially available recogniser on a grammar of approximately 20,000 US surnames showed that the accuracy was not greater than 40%. A grammar to cover all the possible names and words that might occur in an email would be much larger, and the accuracy would therefore be expected to be even lower. An accuracy of less than 40% is clearly not sufficient to support a single step dialogue for email recognition.

Spelling

Spelling recognition is very error prone due to the similarity of many letter sounds in the English alphabet, particularly the ‘E’-set {B,C,D,E,G,P,T,V} and ‘N’ and ‘M’, for example, when communicated over the limited bandwidth of a telephone. Therefore spelling alone does not adequately solve the problem of email address recognition. However, spelling of one or more parts of the email address can be used as a recognition channel that can be used as a descriptor in a multichannel disambiguation approach with subsequent steps to select the correct hypothesis (proposed email addresses). There are various possibilities for the language model that the recogniser uses to recognise the spelling:

i) It is assumed that there is no structure whatsoever in the email address (or part of it), and a model that allows any letter, digit or allowed symbol to follow any other is used;

ii) a statistical n-gram language model is trained on a representative sample of email addresses. However, as e-mail addresses are often composed of words that may be shortened or modified and concatenated together, this statistical model does not currently perform well; and

iii) a grammar is used to constrain the spellings, based on combinations of words, names, letters, numbers and symbols.

DTMF

The telephone keypad can be used as a further channel to enter information about the email address. Each key on the keypad represents a number and three or four letters. For text entry into a mobile phone, each key may be pressed a number of times in order to select the required symbol. DTMF input may be combined with other techniques, as it can provide useful information about each character, or group of characters, in an email address, such as, for example, the length of a character group.

Combining Recognition Approaches

Use of either direct recognition, spelling or DTMF alone do not satisfactorily identify an email address during a dialogue. A multi-channel disambiguation approach may thus be invoked. Spelling or keypad entry using DTMF can be used as the first descriptor of email addresses (the data/information item in question) in a multi channel disambiguation approach. Here we start with an effectively infinite database of all syntactically correct email addresses which is then filtered on the basis of recognition results to reveal a subset of email addresses on which subsequent recognition approaches can be based.

Since we cannot build a grammar to cover all legal email addresses, we build one appropriate to the address we are trying to recognise. To achieve this, we must first narrow down the possibilities. Using DTMF or spelling, for example.

The result of DTMF input is ambiguous since each key on the telephone keypad is used for at least one digit and up to 4 letters. The (geometric) average of the number of possibilities for each key (assuming letters and numbers only) is (1*4*4*4*4*4*5*4*5*1)\hat{ }1/10=3.17. Therefore for a 10 letter email address entered via the telephone keypad, there are approximately 3.17\hat{ }10=102,400 possible spellings.

Similarly, the spelling recognition is inconclusive as some letters are very easily confused over the telephone, causing the recogniser to make frequent substitution errors (e.g. Recognising “S” when the utterance is “F”). Furthermore, co-articulation effects mean that the recogniser is prone to making deletion errors (e.g. recognising “K” when the utterance is “K A”) and insertion errors (e.g. recognising “O R” when the utterance is “R”). Therefore it is necessary to use an n-best list with large n, or to expand the top few hypotheses into all utterances that are likely to have produced these hypotheses. For example, on the assumption that M and N are confusable and K and A are also confusable, the utterance “M A N” could lead to a recognition hypothesis “M K W”. This would then be expanded into:

“M A N”

“N A N”

“M K N”

“N K N”

“M A M”

“N A M”

“M K M”

“N K M”

In the above example, the expansion process has resulted in the actual utterance “M A N” appearing in the expanded hypotheses even though it was not recognised in the first place.

The next step is to build a recognition grammar that will allow the precise email address to be recognised by some other means: either via spelling or natural speech.

The simplest approach is to use DTMF followed by spelling. This will be discussed next.

Combined DTMF/Spelling

The email address is entered using the telephone keypad. The recognised key-presses are used to create a dynamic grammar with which the spelling is recognised.

For example:

To recognise the first part of an email address, e.g. “k_robinson”:

“Please enter the first part of the email address using your telephone keypad, press each key once for letters and numbers, and use the star key for symbols, press the hash key to finish”

Recogniser: “5*76246766”

Dynamic Grammar: “[j k l] [underscore dot dash] [p q r s][m n o] [a b c] [g h I] [m n o] [p q r s] [m n o] [m n o]”

“To confirm, please spell that part of the email address for me”

Recogniser: “k underscore r o b i n s o n”

Unfortunately the layout if the telephone keypad means that some confusable letters are grouped together—“M” and “N” for example are both associated with key number 6. This problem can be overcome by:

i) Using an n-gram trained on the spelling of a representative sample of email addresses to score the top few hypotheses and pick the most likely.

ii) Detecting such situations and asking a suitable question to disambiguate. E.g. “Was that N for November?”

Combined DTMF or Spelling with Spoken Address

The recognised DTMF or the results from a spelling recognition (possibly expanded to include confusable alternatives as above) is processed to produce a grammar for recognising the spoken address. Each alternative is split up into individual words that represent the way it will be spoken (e.g. “K underscore Robinson”) and then transcribed into the appropriate phonetic sequences for recognition.

If no other constraints can be brought to bear, then each string must be exhaustively expanded into all possible word groupings. For example:

K underscore Robinson

K underscore R obinson

K underscore Ro binson

K underscore Rob inson

K underscore Robi nson

. . .

K underscore R obi nson

. . .

K underscore R O B I N S O N

This results in a proliferation of the number of sentences that our grammar must cover, but this method produces a large number of unlikely translations.

We can address such a proliferation by assuming that email addresses tend to be composed of names, words and digits separated by dots, dashes, underscores or nothing. The aim is then to find these structures within the constraints of the DTMF or ambiguous spelling that we have. For example, we can look for sub-strings that match dictionary/predetermined list entries.

E.g.

Email address: “krobinson”

DTMF: “576246766”

Letter Groups: “[j k l] [p q r s] [m n o] [a b c] [g h I] [m n o] [p q r s] [m n o] [m n o]”

Grammar entries: “J robinson”, “K robinson”, “L robinson”, “J robin son”, “K robin son”, “L robin son”etc . . .

A subsequent recognition against this grammar allows the correct address to be selected.

Another approach to filtering the recognition possibilities is to train a statistical model (e.g. an n-gram) on the spellings of the dictionary entries, and use this model to filter unlikely word groupings from a search space consisting of all possible word groupings.

The above are examples of a multi-channel disambiguation approach where the number of data items is effectively infinite. Hence the database is not specified in terms of data items and descriptors, but in terms of constraints among descriptors. The data items are defined as any combination of descriptors that satisfies the constraints among them. It is clear that such a representational alternative is interchangeable with the database representation in all of the embodiments described.

Other Constraints

In the case of the domain name it is possible to query a “WHOIS” database for the particular top-level domain to see whether a hypothesised domain name is actually registered. It is sometimes possible to query a mail server to see if a particular email address is present on that server, but this cannot be relied upon as many servers prevent this kind of access as it poses a security risk. These are additional filtering constraints that can be applied to hypothesised results in order to remove syntactically correct, but non existent email address descriptors.

For a system incorporating the email address recognition mechanism to cope in all cases, it can use a combination of DTMF followed by spoken or spelled input, or Spelled input followed by Spoken input and DTMF if more disambiguation is required (for example when the spoken and spelled input are the same).

Another embodiment of the invention provides a batch mode name and address recognition mechanism. This embodiment, and any variants of it, may be provided by the data selection mechanism illustrated in FIGS. 3 to 6 and/or by the method illustrated in FIG. 7. The batch mode name and address recognition mechanism is operable to recognise recorded messages. The resultant transcriptions may be used to automatically generate mailings, such as, for example, providing the labels necessary for dispatching orders placed by telephone.

In this embodiment, information is received as audio data and converted to an appropriate audio file format (e.g. sphere .wav files). Data structures (comprising records) for processing are then prepared. Each record consists of a number of audio files, each relating to a specific part of an address.

The general method of data processing involves:

i) selecting/creating (using a dynamic grammar (pattern recognition model) creation module) a grammar to recognise an address element (descriptor) on basis of results so far (stored in a repository of previous hypotheses);

ii) recognising recorded audio files using this grammar (pattern recognition model);

iii) repeating steps i) and ii) until all address elements have been recognised; and

iv) determining confidence (based on an analysis of features, such as confidence and probability, of some or all of the recognition hypotheses) and then accepting or rejecting the result(s).

The dynamic grammar (pattern recognition model) creation module takes as input the address element for which the grammar is required, and the n-best results of previous recognitions (from the hypothesis repository). The n-best results of all previous recognitions may be available with their respective associated probabilities/confidences. A dynamic grammar suitable for recognising the required address element in the context of the previous results is returned: e.g. from a database (e.g. the QAS Quick Address Names database including both the Royal Mail Postcode Address File (PAF) and the electoral roll database). For example, the list of hypotheses from the recognition of the postcode can be used to constrain the recognition of street names to those that lie within the boundary of the recognised postcodes. Furthermore the models for recognising streetnames that relate to favoured postcode hypotheses (i.e. those with high confidence, probability or rank in the n-best list of hypotheses) can also be favourably weighted.

In this embodiment, the postcode, streetname, house name or number or other address items are the descriptors of unique names and addresses (data items). The full name and address information being recognised (and thus the desired data/information item selected) by applying the following steps:

i) Recognise the postcode (or incode) using a static grammar; optionally, the dynamic grammar creation module is then called with a list of recognised postcodes (or incodes, the first part of a postcode) and by filtering the database, a fully constrained grammar containing entries for recognising only valid postcodes is returned. The postcode may then be re-recognised using the dynamic grammar.

ii) Call the dynamic grammar creation module with n-best list of recognised postcodes. This returns a dynamic grammar for recognising street names that match the given postcodes.

iii) Recognise a street name (or house name/number, or first line of the address etc.) against the dynamic grammar.

iv) Call dynamic grammar creation module with list of matching postcodes and streetnames (or other part of the address). This returns a grammar for recognising first and last name of all residents in those postcode/street combinations.

v) Recognise a first and a last name against dynamic grammar.

vi) Select the best combination of results (e.g. by an analysis of the consistent descriptors in the hypothesis repository or simply by choosing the top result from the name recognition) and determine confidence (e.g. using the confidence on the name recognition or an analysis of the confidence, probability and other features relating to consistent descriptors in the hypothesis repository)

vii) Accept or reject the hypothesised matches (e.g. by applying a threshold to the confidence of the name recognition).

viii) If accepted, retrieve (and optionally dispatch) the full address information corresponding to one or more of the matches.

Data Despatch

Once one or more address/name has been recognised, the corresponding data can be dispatched, as follows:

i) Format full address information for successfully recognised addresses as required by customer (or to some Vox specified standard);

ii) Package data: Transcribed addresses plus audio files identified as transcribed and not-transcribed-format as required by customer (or to some Vox specified standard)

A further embodiment of the invention provides a mechanism for robust recognition of spoken spellings. This embodiment, and any variants of it, may be provided by the data selection mechanism illustrated in FIGS. 3 to 6 and/or by the method illustrated in FIG. 7.

The recognition of spoken strings of letters is a difficult speech recognition task. Many of the individual letter sounds are acoustically similar, for example the E-set ‘E’, ‘C’, ‘D’, ‘V’, ‘P’, ‘B’, ‘D’ are easily confused, as are ‘S’ and ‘F’—particularly when the voice waveform is conveyed over a band limited communication medium, such as a telephone line. These are known as substitution errors. Other problems arise due to the short duration of each of the letter sounds. This can cause deletion errors, where, for example, the quickly uttered string ‘E S’ may be recognised as ‘S’ alone, and insertion errors, where for example a slowly uttered ‘B’ may be recognised as ‘B E’.

Therefore it is usually necessary to apply the maximum possible constraint to the acoustic pattern matching process, so that ambiguities can be resolved. This can be achieved with a recognition grammar that constrains the possible annunciations of all spellings that must be recognised.

For example, to recognise the surname spelling:

BONNETT

It must be expanded into the possible annunciations to provide a spelling dictionary:

B O double N E double T

B O N N E double T

B O double N E T T

B O N N E T T

This will tend to increase the size of the grammar. In a test with 15,733 U.S surnames an expanded list containing all combinations of the use of “double” included 21,178 entries, an increase of 35%.

An alternative approach is to use a statistical language model known as an N-gram to constrain the spelling recognition process. Here we estimate the probability of each letter in the alphabet following the previous N letters. These estimates are calculated from the spelling dictionary as follows:

For a letter strings X=X1 X2 . . . XM , where M is the number of letters in the string.

We need to find the probability P(Xi|Xi−N+1 . . . Xi−1), that is the probabilities of a particular letter Xᵢ following a sequence of letters X_{i-N+1}

For a tri-gram, N=3, so we estimate:

P(Xi|Xi−2,Xi−1)˜C(Xi Xi−1Xi−2)/C(Xi−1Xi−2)

Where:

C(Xi Xi−1 Xi−2) is the number of occurrences of the letter sequence Xi Xi−1 Xi−2 in the dictionary.

C(Xi−1 Xi−2) is the number of occurrences of the letter sequence Xi−1 Xi−2 in the dictionary.

For example, if we had a dictionary containing just the following 3 entries:

ROBERTS

ROBINSON

ROWLEY

Then we can estimate tri-gram probability P(B)RO) from the following counts:

C(ROB)=2

C(RO)=3

So:

P(B|RO)=C(ROB)/C(RO)=⅔

A Speech recogniser usually hypothesises utterances (e.g. possible recognitions) from left to right as it processes the speech waveform. With an N-gram language model the recogniser can constrain the acoustic pattern-matching task to those letters that have a reasonable likelihood of following the letters that it has so far hypothesised but the constraint is not deterministic, so letter sequences can be recognised that were not in the original dictionary.

Speak and Spell

Certain utterances are difficult for an ASR to recognise, such as names of people or places. Many factors contribute to the difficulty of the task:

i) The need to recognise from a large list of possibilities (e.g. 20K+ surnames) means that the likelihood of confusion is increased.

ii) Problems with finding the correct phoneme transcription(s) of the entries.

iii) Pronunciation variations.

Combining n-best lists:

Robust Recognition of Spelled Utterances

What follows is a description of an embodiment of multi-channel disambiguation for the robust recognition of spoken and spelled utterances. Here the data items—names, have associated descriptors—the spoken name, and the spelled name.

i) Recognise (R1) the spoken name against a fully constrained grammar containing all entries in a dictionary.

If top result (R1) is in dictionary and confidence C11>T1a then select and end. Otherwise select top M results (R11, R12, R13 . . . R1M) for:

a. M=constant

b. M=index of the lowest confidence entry with conf C1i>T1b

c. M=maximum index of entry chosen such that the standard deviation of the hypothesis probabilities in the M-best list is <T1c.

ii) Recognise (R2) the spelled name against a fully constrained probabilistic spelling grammar expanded to include all combinations of “double <letter>”. Entries that match hypotheses from the recognition R1 are given a probability P1. All remaining entries are given a probability P2. In general P1>P2. P2 may be set to zero in which case the grammar only contains the spellings of those entries that were in the n-best list from the previous recognition (R1). Furthermore P1 can be a function of the probability or confidence assigned to the spoken name recognition with which entries are associated.

This grammar (which defines one pattern recognition model) is combined with a spelling n-gram (another pattern recognition model) trained on the expanded dictionary. The relative weight applied to the constrained grammar and the n-gram is tuned to maximise accuracy.

If the highest combined confidence (determined, for example, by a linear combination of the confidence C2i associated result (R2i) and the confidence C1j associated result (R1j) of matching results R1j and R2i as above) C1_2_combined >T2a then select and end.

Otherwise select top N results for:

a. N=constant

b. N=index of the lowest confidence entry with conf C1i>T2b

c. N=maximum index of entry chosen such that the standard deviation of the hypothesis probabilities in the M-best list is <T2c.

iii) Find phoneme transcriptions for entries in N-best list from R2 from dictionary where possible or otherwise using automatic transcription. Re-Recognise (R3) against a recording of the users utterance from R1. Select the hypothesis from R2 that has the highest combined confidence (determined by a linear combination of the confidence C2i associated with result R2i and the confidence C3j associated with result R3j of matching results R2i and R3j as above) C2_3combined>T2a then select and end.

NOTE: the thresholds T1a,T1b,T1c,T2a,T2b,T2c and the coefficients for the linear combinations used to derive the combined confidences are tuned to achieve maximum accuracy.

Another embodiment of the invention provides a location determination mechanism that uses multi-channel disambiguation. This embodiment, and any variants of it, may be provided by the data selection mechanism illustrated in FIGS. 3 to 6 and/or by the method illustrated in FIG. 7.

There are many fields in which it is desirable to identify a single data item from a plurality of data items each having a number of distinct descriptors. The descriptors may be provided as variables for use in a data processing apparatus. Where the number of descriptors/variables is four, for example, we call such an allocation a quadruple; more generally we refer to n-tuples. Where constraints exist between the descriptors, such a problem is referred to as a constraint satisfaction problem (CSP). In the published literature, efficient algorithms have been developed for tackling this class of problem; their power derives mainly from exploiting the notion of consistency i.e. minimise effort spent searching areas of the search space where constraint violations occur.

Some of the fields of application relate to situations where we would like to be able to deploy a SLI. Consider, for example, the problem of helping a user to identify his current location.

In this embodiment, a system employing the location determination mechanism in a SLI is able to help as the user provides clues such as landmarks and street names by combining its interpretation of the user's responses with constraints imposed by the domain in question.

A first stage involves the formalisation and representation of the streams of information around which the dialogue will be formed, and in terms of which a solution (a uniquely identified location) will be postulated. In this location-finding embodiment, the streams of information may be names of streets, addresses and locations of banks, phone boxes, fast-food chains and so on. As only a limited number of streams can be acquired and processed, the most informative open streams and the accuracy with which data items associated with these streams can be recognised are identified. It should also be borne in mind that the efficacy of information streams in identifying a particular solution (the caller's location, for example) is related to the actual solution(s) currently under consideration, that is those solutions that remain consistent with the information collected from the user so far. For example, the fact that someone has a post box within their line of sight may tell us less about their location if they are in a large city centre than if they are in a rural backwater.

In location finding, for example, we might consider some or all of the following sets of landmarks (descriptors):

Pillar boxes;

Phone box locations;

Banks & ATMs;

Chain stores;

Restaurants, pubs;

Traffic lights;

Fast food outlets;

Street intersections.

A key feature of all of these candidate fields is that essentially they specify point locations rather than larger regions. In some situations broader (hierarchical) constraints such as town names, parks, districts, streetnames and so on can be used as information streams.

For the purpose of elaborating further details of our technique, however, we assume access to a database in which is stored all the relevant information required.

Desirable qualities for an ideal location finder are:

i) It should be sure and certain of the answer it arrives at on completion of the dialogue.

ii) If significant doubt is attached to the best available answer, this must be brought to the user's attention

iii) It should take a minimum of time and effort (roughly equivalent to dialogue ‘turns’) to arrive at stage 1 above.

iv) It must handle errors , from whatever origin, in a resilient way. The three main sources of error are:

a) Speech recognition errors—where the correct transcription/interpretation of the users utterance does not appear in the one or more recogniser hypotheses taken into consideration.

b) User information error—where the user does not respond to the prompt correctly.

c) Constraint specification error—where the database in which (typically) the constraints are stored contains errors.

These qualities can be achieved by employing a multichannel disambiguation approach.

Directed Dialogue

If we allow users too much freedom within the dialogue, we have to confront the problem of semantic qualifiers, which identify the logical relationship between the user and the landmark reference token in the utterance. For example:

I am outside Lloyds bank.

I am near the Tower.

I am quite far from the station.

I cannot see any traffic lights.

Each of these expressions implies a quite different kind of relationship. It is not straightforward to identify and accurately inter these qualifying expressions. Therefore for the present embodiment, we confine our attention to a directed dialogue, where this problem can be side-stepped. However, it is envisaged that future embodiments will be able to use non-directed dialogue.

Overview of the Algorithm

The are three major elements to the algorithm:

i) Terminate when only a single unifier (i.e. data item) is consistent with the values already recognised.

ii) An information-based heuristic for determining which question to ask, if termination is not achieved. In rare cases, even when termination is not achieved, nevertheless asking further questions may not help. The algorithm should accommodate such cases.

iii) A mechanism for determining whether the algorithm is (still) on the right path to find a solution, and if not, to initiate a recovery procedure.

In rare circumstances, it is possible that one or more erroneous recognition results will yield descriptor values that remain consistent with one or more data items. Much more frequently, however, will be the circumstance where one or more misrecognitions will yield descriptor value hypotheses that are not consistent with any data items. Consequently no data items will remain in the filtered data set. Strategies for recovering from such situations are described below.

Algorithm Steps

a. Return value & terminate if only one location (unifier/data item) remains for the values asked so far

b. Select the next descriptor to consider. There may either be a default (hard-coded) ordering, or the descriptor may be selected dynamically. Example: location descriptors might suit a default ordering: street, road, restaurant, pub. Partial ordering may also be possible.

c. Use a measure based on Shannon's Uncertainty Function to select the most appropriate next descriptor F to ask for on the basis of the expected information gain.

d. Posit a (dynamic) grammar (or other pattern recognition model) containing, for example, all consistent values for F. {See below for further explanation and alternative}.

e. Recognise the user generated input relating to descriptor F in order to generate a (n-nest) list of hypothesised descriptor values, NF

f. Go back to first step

Recovery Procedure

It is pretty well certain that on some occasion, there will be a need for some sort of recovery. We can identify (at least) two kinds of possible scenarios:

i) Consistency failure

In this situation the user's input is recognised as not being in the part of the grammar (or other pattern recognition model) which is consistent with (some sequence or other of) the values of the hypothesised values of the previously considered descriptors. Hence, the filtered data set will contain zero data items.

ii) User does not confirm the response

Here, the algorithm has returned an incorrect value to the user, but the user has rejected it. This implies that there was a chance match between erroneous descriptor values and a single data item.

Recovery Options

In either of the two scenarios above, we have two options for how to recover:

i) try to identify erroneous set or sets of descriptor values. We do not know which of the recognition results (set of hypothesised descriptor values) is (or are) culpable. However, for k sets of hypothesised descriptor values, we can straightforwardly determine which combinations of k−1 recognition results that yield a non-empty set of remaining information/data items. [Or, in case of multiple misrecognition, (k−2), (k−3) etc]. This identifies a descriptor or descriptors, the hypothesised values of which are likely to be erroneous, i.e they do not include the descriptor value that was input by the user, or were the result of the user inputting a descriptor value that was inconsistent with the other descriptors they have input (due to a mistake on the part of the user, or an error in the database or constraint satisfaction module).

Once the likely culprits are identified there are several options:

i) User input relating to already considered descriptors can be reanalysed in order to repair the error and arrive at a non-empty filtered data set.ii) The system can continue by considering new descriptors while maintaining a data set filtered such that the descriptors of the remaining data items are consistent with at k−1 hypothesised descriptor values, terminating when such a dataset contains a single data item. iii) in an on-line system, the user can be asked to provide a descriptor value again, perhaps with a different prompting strategy.

Another way of recovery is:

When the user rejects a tuple as being his location, we can cost the process of moving from that consistent tuple to another one. The formula for evaluating these costs is based on:

a) the relative depth of the new value in the n-best list

b) the number of fields where a value needs to be changed

c) preserving the highest possible combined confidence

It may well be that we want to employ a different recovery strategy according to whether the cause is consistency failure, or user rejection. Culprit identification, for instance, may be more appropriate in the rejection scenario, since we probably would like to prompt for a field that has been asked already

Dynamically Creating the Pattern Recognition Models

In general, the dynamic grammar (pattern recognition model) for recognising a descriptor value input by the user can contain all possible values for that field in the database. However, where the descriptor under consideration is not the first, then it is possible to create a dynamic model that is conditioned on previously hypothesised descriptor values. Each descriptor value in the grammar can be weighted according to the evidence in the hypothesis history that supports it. For example, if there are k sets of descriptor hypotheses in the hypothesis depository (the system having considered k descriptors so far) and a descriptor value associated with the next descriptor under consideration is consistent with m data items in k−n of these hypothesised sets (the intersection of k−n hypothesis sets yields a set of data items, m of which have a descriptor value that matches one of the possible values of the next descriptor in question), then the evidence (in terms of consistency) supporting the existence of this descriptor value in the pattern recognition model is some function f(n,m) and hence the weight of this value in the pattern recognition model may be defined by some function g(n,m) such as W1=A*m*(k−n), the motivation here is that the amount of evidence is proportional to both the number of descriptor hypothesis sets with which the value is consistent and also to the number of data items that are consistent with them (assuming that each data item is equally likely a priori)

The weighting can also be conditioned on the combined confidence, or probability that the recogniser attaches to the previously hypothesised descriptor values that support the new descriptor value under consideration.

Information-Based/Uncertainty Function

Here we are interested in selection of the data item U={U1,U2 . . . Un}. The amount of information required to uniquely identify the data item (Ui) of the unifier can be determined using Shannon's information heuristic.

I(U)=−sum of P(Ui)*log2P(Ui)

Where P(Ui) is the probability that the unifier value Ui is what the user is referring to (e.g. the grid reference of their location).

We wish to prompt the user in such a way that we uniquely identify the data item/unifier as quickly as possible. The concept of information gain can be used to guide the process.

The reduction in uncertainty (information gained) when the value of a descriptor T={T1,T2, . . . TM) is identified as Tj is determined by the difference in the amount of information required to uniquely identify a data/information item before the value of descriptor T is known, and the information required afterwards once its value is known to be Tj.

Gain(U|Tj)=I(U)−I(U,Tj)

Where:

I(U,Tj)=−Sum i=1 to M P(Ui|Tj)log P(Ui|Tj) P(Ui|Tj) is the probability of the data item Ui being what the user is referring to given that we already know that the value of field T=Tj.

Since we do not know in advance which answer the user will give us, we cannot know in advance exactly how much information will be gained, but we can determine the average information gain as a sum of the information gained for each possible value of descriptor T weighted by the probability that the value of descriptor T turns out to be Tj:

Gain(U|T)=Sum j=1 to |T|[I(U)−P(Tj)*I(U,Tj)]

In order to determine the next question to ask according to the information gain heuristic described above we must determine P(Ui) and P(Ui|Tj). In general this could be quite difficult so we need to make some simplifying assumptions.

Correctness assumption with Uniform unifier probability:

If we assume that:

a) the user's utterances are recognised correctly. (i.e. the correct interpretation of their response to each question occurs somewhere in the list of hypotheses returned by the recogniser) and

b) the likelihood of unifiers that do not violate constraints is equal,

then the required probability distributions can be easily determined. Clearly, different assumptions will lead to different expressions, but the principles remain the same.

Under these assumptions we can determine the probability distributions as follows:

P(Ui)=1/N if no constraints relating to data item Ui are violated by information collected so far. =0 otherwise.

Where N=the number of data items that are consistent with the information collected so far. P(Ui|Tj)=1/Mj if no constraints relating to data item Ui are violated by information collected so far or by descriptor T taking the descriptor Tj. =0 otherwise.

Where Mj=the number of unifiers that are consistent with the information collected so far and with decriptor T taking the value Tj

For uniform probability distributions the information heuristic simplifies to:

I(U)=−Sum i=1 to N P(Ui)log P(Ui)

−Sum i=1 to N (1/N)*log(1/N)

−log(1/N)

−log(1)+log(N)

log(N)

And similarly:

I(U,Tj)=log(Mj)

So the average information gain is:

G(T)=Sum over j of p(Tj)(log(N)−log(Mj))

=Sum over j of 1/Mj*(log(N/Mj))

The descriptor with the highest expected information gain can then be chosen.

So far we have assumed that the value of a field will be identified uniquely by the user's response to a question. In practice however we often need to consider several possible interpretations of a user's utterance. This complication is dealt with in the next section.

Information Gain with n-Best Lists

A speech recogniser can be viewed as a device for making phonetic distance measurements between an utterance and entries in a vocabulary. Ideally it will pick the vocabulary item that is most phonetically similar to the user's utterance and hence achieve a high accuracy rate. Unfortunately both speech production and speech recognition are noisy processes. This means that incorrect hypotheses may be ranked more highly than correct ones. To overcome this we often consider the top N hypotheses returned by the recogniser. We must consider this when applying the information gain heuristic in our choice of prompting strategy.

We will assume for simplicity that a list of N hypotheses are returned in response to a single user utterance, and that each of these are considered equally likely to correspond to the user utterance. In order to apply the information heuristic we must estimate which vocabulary items are most likely to occur in the n-best list for each possible utterance. Ideally this estimate will be based on empirical evidence. It will usually be impractical to directly estimate the likelihood of each vocabulary item occurring in the n-best list in response to a certain user utterance. Instead a confusion probability matrix can be estimated for phoneme deletion, insertion, and substitution occurrences in real recognition data. This constitutes a measurement of phonetic similarity from the point of view of the recogniser. The phonetic distance between the two vocabulary items can then be estimated joint probability of phoneme insertion deletion and substitution operations that transforms the phonetic transcription of one item into the other. In principle we should perform a sum over all appropriate combinations of these operations, but in practice we can assume that the probability of the most probable transformation is approximately equal to the sum over all combinations. Under these assumptions, and in the confusion matrix is defined in terms of log likelihoods then the phonetic similarity between two vocabulary items can be defined as the string edit distance between them.

The list of N hypotheses most likely to be returned in response to an utterance corresponding to vocabulary item Xj can now be predicted by selecting the N most phonetically similar vocabulary items.

When we consider a number of results in parallel, as we do when considering the n-best lists, we have gained much less specific information then if we were to consider a single result, but the likelihood of relying on incorrect information is reduced. In order to achieve the optimum balance between these two considerations it will be necessary to tune the method by which the number of hypotheses taken into consideration is determined. So far we have tacitly assumed that the number of hypotheses will be constant, or at least determined for each question in advance, but the methodology described above can be used to determine the value dynamically as a function of the confusability of the descriptor values.

Example Data Set

Below are some fictitious locations, defined in terms of regions and landmarks. Arbitrary alphanumeric co-ordinates serve as unifiers.

Town; Street; Eatery; Pub; Unifier

London; Piccadilly; The Ritz; The Green Man;N14

London; Victoria Street; McDonalds; Albert; N2

London; Victoria Street; Aberdeen Angus; Duke of York; N3

London; Victoria Street; Mumtaz; Shakespeare; N4

London; Palace Street; Kate's Cafe; Phoenix; N5

London; Wilton Street; Burger King; Colonies; N6

London; Piccadilly; Pizza Hut; Red Lion; N7

London; Victoria Street; Spaghetti Place; Coach and Horses; N8

London; Victoria Street; The Thai Kitchen; The Queen's Legs; N9

London; Victoria Street; Pizza Express; The Penny Black; N10

London; Palace Street; Prét à manger; Royal Oak; N11

London; Wilton Street; Benjy's Pint Pot; N12

London; Upper Street; Pizza Hut; Pig and Whistle; N13

London; Upper Street; Pizza Express; Shakespeare; N14

London; Upper Street; Mumtaz; Frog and Parrot; N15

London; Upper Street; Prét à manger; Queen's Head; N16

London; Old Street; Burger King; King George; N17

London; Old Street; McDonalds; Royal Oak; N18

London; Old Street; Tiger Lil's; Red Lion; N19

London; Old Street; Benjy's; King Edward; N20

London; Warwick Row; Pizza Express; Albert; N21

Leeds; Piccadilly; Prét à manger; The Queen's Head; L1

Leeds; Victoria Street; Pizza Express; The Penny Black; L2

Leeds; Victoria Street; Spaghetti Place; The Green Man; L3

Leeds; Victoria Street; Aberdeen Angus; Shakespeare; L4

Leeds; Palace Street; Mumtaz; Shakespeare; L5

Leeds; Wilton Street; Burger King; Royal Oak; L6

Leeds; Piccadilly; The Thai Kitchen; Royal Oak; L7

Leeds; Victoria Street; Kate's Café; Red Lion; L8

Leeds; Victoria Street; Benjy's; Red Lion; L9

Leeds; Victoria Street; Pizza Hut; Queen's Head; L10

Leeds; Palace Street; McDonalds; Pint Pot; L11

Leeds; Wilton Street; Prét à manger; Phoenix; L12

Leeds; Upper Street; Benjy's; King George; L13

Leeds; Upper Street; Tiger Lil's; King Edward; L14

Leeds; Upper Street; The Thai Kitchen; Frog and Parrot; L15

Leeds; Upper Street; Tiger Lil's; Duke of York; L16

Leeds; Old Street; Spaghetti Place; Colonies; L17

Leeds; Old Street; Burger King; Coach and Horses; L18

Leeds; Old Street; Wimpy; Cat and Whistle; L19

Leeds; Old Street; Muntaz; Albert; L20

Leeds; Warwick Row; Prét à manger; Albert; L21

Luton; Victoria Street; Burger King; Royal Oak; T1

Luton; Victoria Street; McDonalds; Pig and Whistle; T2

Luton; Victoria Street; Pizza Hut; Merry Monk; T3

Luton; Victoria Street; Pizza Express; The Ship; T4

Luton; Victoria Street; Mumtaz; King Edward; T5

Luton; Victoria Street; Benjy's Red Lion; T6

Luton; Victoria Street; Wimpy; Shakespeare; T7

Luton; Victoria Street; Prét à manger; Penny Black; T8

Luton; Victoria Street; McDonalds; Queen's Head; T9

Luton; Victoria Street; Burger King; Pint Pot; T10

Luton; Victoria Street; Tiger Lil's; Green Man; T11

Luton; Palace Street; Wimpy; Coach and Horses; T12

Luton; Palace Street; Tiger Lil's; King George; T13

Luton; Palace Street; Prét à manger; Albert; T14

Luton; Palace Street; Prét à manger; Yates's; T15

Luton; Palace Street; Pizza Hut; Queen Victoria; T16

Luton; Palace Street; Pizza Express; The Partridge; T17

Luton; Palace Street; Mumtaz; Britannia; T18

Luton; Palace Street; McDonalds; The Britannia; T19

Luton; Palace Street; McDonalds; The Penny Red; T20

Luton; Palace Street; Burger King; Scott's; T21

Luton; Palace Street; Burger King; Phoenix; T22

Luton; Palace Street; Benjy's; Queen's Head; T23

Luton; Palace Street; Pizza Hut; Oscar's; T24

Suppose we want to identify a user's co-ordinate location (the unifier or data item) by asking him about some combination of the other four fields (descriptors) in the table above. Suppose too, that for this problem, a partial ordering of the fields is appropriate. So, we would ask the town first, followed by the street name. Then whether to ask the name of the eatery or the name of the pub is determined by applying the information gain function to the sequence of values, for each field, which are consistent with the fields already recognised (i.e. town and street name). Each time a question is asked, we retain the n-best set of values (descriptor hypotheses), but for this example only the highest ranked descriptor hypothesis (in terms of probability, confidence or some other distance measure) will be used to filter the data set. This value is used to constrain the values available for subsequent fields, by cross-referencing in the database and dynamically creating a recognition model.

Hence after question 1, we receive an n-best list: { Luton; London: Leeds }

Selecting Luton (the first-best hypothesis) and filtering the data set, this leaves:

Luton; Victoria Street; Burger King; Royal Oak; T1

Luton; Victoria Street; McDonalds; Pig and Whistle; T2

Luton; Victoria Street; Pizza Hut; Merry Monk; T3

Luton; Victoria Street; Pizza Express; The Ship; T4

Luton; Victoria Street; Mumtaz; King Edward; T5

Luton; Victoria Street; Benjy's; Red Lion; T6

Luton; Victoria Street; Wimpy; Shakespeare; T7

Luton; Victoria Street; Prét à manger; Penny Black; T8

Luton; Victoria Street; McDonalds; Queen's Head; T9

Luton; Victoria Street; Burger King; Pint Pot; T10

Luton; Victoria Street; Tiger Lil's; Green Man; T11

Luton; Palace Street; Wimpy; Coach and Horses; T12

Luton; Palace Street; Tiger Lil's; King George; T13

Luton; Palace Street; Prét à manger; Albert; T14

Luton; Palace Street; Prét à manger; Yates's; T15

Luton; Palace Street; Pizza Hut; Queen Victoria; T16

Luton; Palace Street; Pizza Express; The Partridge; T17

Luton; Palace Street; Mumtaz; Britannia; T18

Luton; Palace Street; McDonalds; The Britannia; T19

Luton; Palace Street; McDonalds; The Penny Red; T20

Luton; Palace Street; Burger King; Scott's; T21

Luton; Palace Street; Burger King; Phoenix; T22

Luton; Palace Street; Benjy's; Queen's Head; T23

Luton; Palace Street; Pizza Hut; Oscar's; T24

Next, we ask the street name, receiving an n-best list: { Palace Street; Victoria Street }

Selecting Palace Street (the first best hypothesis), and filtering the data set, this leaves the following portion of the database:

Luton; Palace Street; Wimpy; Coach and Horses; T12

Luton; Palace Street; Tiger Lil's; King George; T13

Luton; Palace Street; Prét à manger; Albert; T14

Luton; Palace Street; Prét à manger; Yates's; T15

Luton; Palace Street; Pizza Hut; Queen Victoria; T16

Luton; Palace Street; Pizza Express; The Partridge; T17

Luton; Palace Street; Mumtaz; Britannia; T18

Luton; Palace Street; McDonalds; The Britannia; T19

Luton; Palace Street; McDonalds; The Penny Red; T20

Luton; Palace Street; Burger King; Scott's; T21

Luton; Palace Street; Burger King; Phoenix; T22

Luton; Palace Street; Benjy's; Queen's Head; T23

Luton; Palace Street; Pizza Hut; Oscar's; T24

Now, to select the next question, we apply the information gain heuristic. For this illustration, we can simplify the maths a bit: each field has 13 values. The one with the fewest number of duplicates provides more information. (We make the reasonable assumption that the relative incidence of each distinct value gives a fair approximation of the probability of a user offering that value. Moreover, the chances of having to ask another question are higher when the field contains more duplicates). So, we ask the pub name, and receive the following n-best list:

{ Queen Victoria; Queen's Head; Phoenix }

Selecting Queen Victoria (the highest ranked hypothesis) this leaves just one unifier (data item) consistent with all the values asked so far (shown in bold):

Luton; Palace Street; Pizza Hut; Queen Victoria; T16

We thus offer the unifier T16 to the user.

Example of Recovery

In the section on recovery, we suggested two main ways in which things could go wrong.

In the first of these, the latest recognition returns an n-best list in which the topmost element does not lie within the values for that field which are consistent with the values to which we have committed so far. We then have a choice over which field, or fields, should use a value lower down in the n-best list. We use a tailor-made function which thus estimates the cost of alternative solution tuples, with respect to the given recognition results.

We consider, in turn, each of the k questions asked so far. In the example above, we asked three questions. Let us suppose that, for the pub field, we received instead the following n-best list:

{ Pig and Whistle; Merry Monk; Phoenix; Pint Pot }

This result is inconsistent with the already recognised responses. So we begin recovery. Effectively, we suspend each field's result in turn, and evaluate the highest scoring consistent with the other populated fields. We reward high-confidence recognitions (those at, or near the top, of the n-best list), and penalise having to select a replacement value. We would also prefer to avoid asking further question unless we must.

Field considered: New consistent tuple: Edit cost: Further question(s)

pub: {Luton, Palace St, Pint Pot}:High: yes

town: {London, Palace St, Phoenix}: 3 (At least): yes

street: (Luton, Victoria St, Pig & Whistle}: 1: no

So in this example, we would opt for changing the street to Victoria St.

Although the invention has been described in relation to one or more mechanism, method, interface, and/or system, those skilled in the art will realise that any one or more such mechanism, interface and/or system, or any component thereof, may be implemented using one or more of hardware, firmware and/or software. Such mechanisms, methods, interfaces and/or systems may, for example, form part of a distributed mechanism, interface and/or system providing functionality at a plurality of different physical locations.

Insofar as embodiments of the invention described above are implementable, at least in part, using an instruction controlled programmable processing device such as, for example, a Digital Signal Processor, microprocessor, data processing apparatus or computer system, it will be appreciated that instructions (e.g. computer software) for configuring a programmable device, apparatus or system to implement the foregoing described methods is envisaged as an aspect of the present invention. The instructions may be embodied as source code and undergo compilation for implementation on a processing device, apparatus or system, or may be embodied as object code, for example. The skilled person would readily understand that the term computer system in its most general sense encompasses programmable devices such as referred to above, and data processing apparatus and firmware embodied equivalents, whether part of a distributed computer system or not.

Software components may be implemented as plug-ins, modules and/or objects, for example, and may be provided as a computer program product stored on a carrier medium in machine or device readable form. Such a computer program may be stored, for example, in solid-state memory, magnetic memory such as disc or tape, optically or magneto-optically readable memory, such as compact disc read-only or read-write memory (CD-ROM, CD-RW), digital versatile disc (DVD) etc., and the processing device utilises the program or a part thereof to configure it for operation.

The computer program product may be supplied from a remote source embodied on a communications medium such as an electronic signal, radio frequency carrier wave or optical carrier wave. Such carrier media are also envisaged as aspects of the present invention.

Although the invention has been described in relation to the preceding example embodiments, it will be understood by those skilled in the art that the invention is not limited thereto, and that many variations are possible falling within the scope of the invention. For example, methods for performing operations in accordance with any one or combination of the embodiments and aspects described herein are intended to fall within the scope of the invention. As another example, those skilled in the art will understand that any communication link between a user and a mechanism, interface and/or system according to aspects of the invention may be implemented using any available mechanisms, including mechanisms using of one or more of: wired, WWW, LAN, Internet, WAN, wireless, optical, satellite, TV, cable, microwave, telephone, cellular etc. The communication link may also be a secure link. For example, the communication link can be a secure link created over the Internet using Public Cryptographic key Encryption techniques or as an SSL link. Embodiments of the invention may also employ voice recognition techniques for identifying a user.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features and sub-features from the claims may be combined with those of any other of the claims in any appropriate manner and not merely in the specific combinations enumerated in the claims. Additionally, the applicant hereby gives notice that features of the various embodiments may also be combined in any appropriate manner with features of the embodiments, description and/or claims to formulate one or more new claims.

There now follows a set of numbered clauses that define various embodiments of the invention:

1. A data selection mechanism for identifying a single data item from a plurality of data items, each data item having an associated plurality of related descriptors each having an associated descriptor value, the data selection mechanism comprising:
a pattern matching mechanism for identifying candidate matching descriptor values that correspond to user-generated input, wherein the pattern matching mechanism is operable to apply one or more pattern recognition models to first user-generated input to generate zero or more hypothesised descriptor values for each of said one or more pattern recognition models; and
a filter mechanism for providing a filtered data set comprising said single data item, wherein the filter mechanism is operable to:
i) create a data filter from the hypothesised descriptor values produced by said one or more pattern recognition models to apply to the plurality of data items to produce a filtered data set of candidate data items; and
ii) select and/or create one or more subsequent pattern recognition models for applying to further user-generated input.

2. The data selection mechanism of claim 1, operable to select and/or create said one or more pattern recognition models in dependence on previously hypothesised descriptor values and/or in accordance with the number of previous hypothesised descriptor values with which said one or more pattern recognition models is/are consistent.

3. The data selection mechanism of claim 1, wherein each hypothesised descriptor value has an associated confidence value, and the data filter criteria correspond to descriptors for which the associated confidence value of the descriptors exceeds a predetermined threshold confidence value.

4. The data selection mechanism of claim 1, wherein the filter mechanism comprises a dynamic ordering mechanism for controlling the order in which user-generated input is analysed by the pattern matching mechanism.

5. The data selection mechanism of claim 4, wherein the dynamic ordering mechanism is operable to apply an information gain heuristic to the descriptors of the data items in the filtered data set to determine an ordered set of descriptors ranked according to the amount of additional information the associated descriptor values will provide.

6. The data selection mechanism of claim 1, wherein further user-generated input is requested from a user.

7. The data selection mechanism of claim 1, wherein further user-generated input is obtained from one or more predetermined user-generated input.

8. The data selection mechanism of claim 1, wherein the user-generated input is input in the form of at least one of: a GPS or other electronic location related information data input, keyed input, text input, spoken input, audible input, written input and graphic input.

9. The data selection mechanism of claim 1, further comprising an error recovery mechanism for performing an error recovery operation should the filtered data set be an empty set.

10. The data selection mechanism of claim 1, wherein the filter mechanism further comprises a hypothesis history repository for storing hypotheses generated by the pattern recognition models.

11. The data selection mechanism of claim 1, wherein the pattern matching mechanism performs voice recognition.

12. A spoken language interface mechanism comprising the data selection mechanism of claim 11.

13. The spoken language interface mechanism of claim 12, for identifying one or more of: a spoken name and/or address, an e-mail address, a car registration plate, identification numbers, policy numbers and a physical location.

14. A method for identifying a single data item from a plurality of data items, each data item having an associated plurality of related descriptors each having an associated descriptor value, the method comprising:
a) operating a pattern matching mechanism to apply one or more pattern recognition models to user-generated input and generating zero or more hypothesised descriptor values for each of said one or more pattern recognition models;
b) creating a data filter from the hypothesised descriptor values produced by the one or more pattern recognition models and applying the data filter to the plurality of data items to produce a filtered data set of candidate data items; and
c) dynamically selecting and/or creating one or more further pattern recognition models and repeating steps a) and b) until a final filtered data set contains either the single data item or zero data items.

15. The method of claim 14, comprising selecting and/or creating said one or more pattern recognition models in dependence on previously hypothesised descriptor values and/or in accordance with the number of previous descriptor values with which said one or more pattern recognition models is/are consistent.

16. The method of claim 14, wherein each hypothesised descriptor value has an associated confidence value, and the data filter criteria correspond to descriptors for which the associated confidence value of the descriptors exceeds a predetermined threshold confidence value.

17. The method of claim 14, further comprising controlling the order in which user-generated input is analysed by the pattern matching mechanism.

18. The method of claim 17, further comprising applying an information gain heuristic to the descriptors of the data items in the filtered data set to determine an ordered set of descriptors ranked according to the amount of additional information the associated descriptor values will provide, and selecting the user-generated input with the highest rank for subsequent analysis.

19. The method of claim 14, further comprising requesting further user-generated input from a user.

20. The method of claim 14, further comprising obtaining further user-generated input from one or more predetermined user-generated input.

21. The method of claim 14, comprising the step of a user providing user-generated input in the form of at least one of: a GPS or other electronic location related information data input, keyed input, text input, spoken input, audible input, written input and graphic input.

22. The method of claim 14, further comprising the step of invoking an error recovery process conditional on the final filtered data set containing zero data items.

23. The method of claim 14, further comprising performing voice recognition.

24. A program product comprising a carrier medium having program instruction code embodied in said carrier medium, said program instruction code comprising instructions for configuring at least one data processing apparatus to provide the data selection mechanism of claim 1, the spoken language interface mechanism of claim 12, or to implement the method according to claim 14.

25. The program product according to claim 24, wherein the carrier medium includes at least one of the following set of media: a radio-frequency signal, an optical signal, an electronic signal, a magnetic disc or tape, solid-state memory, an optical disc, a magneto-optical disc, a compact disc and a digital versatile disc.

26. A data processing mechanism comprising at least one data processing apparatus configured to provide: the data selection mechanism of claim 1; the spoken language interface mechanism of claim 12; or to implement the method according to claim 14.

27. A method of recognising an address spoken by a user using a spoken language interface, comprising the steps of:
forming a grammar of postcodes;
asking the user for a postcode and forming a first list of the n-best recognition results;
asking the user for a street name and forming a second list of the n-best recognition results;
cross matching the first and second list to form produce a first list (Matches 1), of valid postcode-streetname pairings;
if the first list (Matches1) is positive, selecting an element from the match according to a predetermined criterion and confirming the selected match with the user
if the match is zero or the user does not confirm the match;
asking the user for a first portion of the postcode and forming a third list of the n-best recognition results;
asking the user for a town name and forming a fourth list of the n-best recognition results;
cross matching the third and fourth lists to form a second match;
if the second match has more or less than a single entry, passing the user from the spoken language interface to a human operator;
if the second match has a single entry, confirming the entry with the user; and
passing the user from the spoken language interface to a human operator if the user does not confirm the entry.

28. A method according to claim 27, wherein the step of forming the first list of n-best results comprises assigning a confidence level to each of the n-best results.

29. A method according to claim 28, wherein the step of forming the second list of n-best results comprises assigning a confidence level to each of the n-best results.

30. A method according to claim 29, wherein the step of selecting an element from the first match comprises selecting the element with the highest combined confidence if there are more than one matches.

31. A method according to claim 27, wherein the steps of forming the second n-best list comprises dynamically forming a grammar of street names from the postcodes comprising the first n-best list.

32. A method according to claim 27, wherein the step of forming the fourth n-best list comprises dynamically forming a grammar of town names from the first portions of the postcodes forming the third n-best list.

33. A method according to claim 27, wherein the first portion of the postcode is an area code.

34. A method according to claim 27, wherein the step of confirming a single entry comprising the second match, comprises: cross matching the second match with the first and second n-best lists to form a third match; and confirming the third match with the user.

35. A method according to claim 34, comprising:
if the third match contains a single element, asking the user to confirm the address and postcode in that element as correct; and
if the third match contains more than one element, asking the user for a second portion of the postcode and cross matching the received second part of the postcode with the elements of the third match to form a fourth match.

36. A method according to claim 35, wherein if the fourth match has a single element, the spoken language interface asks the user to confirm the details of that element, and if the fourth match does not have a single element the user is passed to a human operator.

37. A computer program having code which, when run on a spoken language interface, causes the spoken language interface to perform the method of claim 27.

38. A spoken language interface, comprising:
an automatic speech recognition unit for recognising utterances by a user;
a speech unit for generating spoken prompts for the user;
a first database having stored therein a plurality of postcodes;
a second database, associated with the first database, having stored therein a plurality of street names;
a third database associated with the first and second databases having stored therein a plurality of town names; and
an address recognition unit for recognising an address spoken by the user, the address recognition unit comprising:
a static grammar of postcodes using postcodes stored in the first database;
means for forming a first list of n-best recognition results from a postcode spoken by the user using the postcode grammar;
means for forming from a street name spoken by the user a second list of n-best recognition results;
a cross matcher for producing a first match containing elements in the first and second n-best lists;
a selector for selecting an element from the list if the match is positive, according to a predetermined criterion, and confirming the selection with the user;
means for forming a third list of n-best recognition results from a first portion of a postcode spoken by the user;
means for forming a fourth list of n-best recognition results from a town name spoken by the user;
a second cross matcher for cross matching the third and fourth n-best hits to form a second match;
means for passing the user from the spoken language interface to a human operator; and
means for causing the speech unit to ask the user to confirm an entry in the single match;
wherein, if the second match has more or less than a single entry or the user does not confirm an entry as correct, the user is passed to a human operator.

39. A spoken language interface according to claim 38, wherein the means for forming the first n-best list includes means for assigning a recognition confidence level to each entry on the list.

40. A spoken language interface according to claim 39, wherein the means for forming the second n-best list includes means for assigning a recognition confidence level to each entry on the list.

41. A spoken language interface according to claim 40, wherein the selector comprises:
means for selecting the element from the match with the highest combined confidence; and
means for dynamically generating a street name grammar using street names from the second database based on the postcodes of the first list.

42. A spoken language interface according to claim 38, comprising means for dynamically generating a street name grammar using street names from the second database based on the postcodes of the first list.

43. A spoken language interface according to claim 38, comprising means for dynamically generating a town name grammar using town names from the third database based on the first portion of the postcodes of the third list.

44. A spoken language interface according to claim 38, comprising a third cross matcher for cross matching the elements of the second match with the first and second n-best lists to form a third match.

45. A spoken language interface according to claim 44, comprising: means for causing the speech unit to ask the user to confirm the address and postcode contained in an element of the third match if the third match contains a single element; and a fourth cross matcher for cross matching the received second portion of the postcode with the elements of the third match to form a fourth match.

46. A spoken language interface according to claim 45, comprising means for causing the speech unit to ask the user to confirm details of an element of the fourth match if the fourth match contains a single element.

47. A method of recognising an address spoken by a user using a spoken language interface, comprising the steps of:
cross matching a postcode and a street name spoken by a user to form a first lost of possible matches;
if the match is not confirmed, cross matching a portion of the postcode and a town name spoken by the user to form a second list of possible matches; and passing the user to a human operator if the second list does not comprise a single entry or confirming the single entry with the user.

48. (Canceled)

49. The data selection mechanism of claim 1, wherein said data selection mechanism is operable in batch mode.

50. The data selection mechanism of claim 1, further operable to apply multi-channel disambiguation (MCD) to identify said single data item.

51. The method of claim 14, comprising applying multi-channel disambiguation (MCD) to multiple associated descriptors.

52. A computer program for configuring the data selection mechanism of claim 1, the spoken language interface of claim 12, or for implementing the method of claim 14.

53. A method according to claim 27, wherein the step of forming the second list of n-best results comprises assigning a confidence level to each of the n-best results.

54. A spoken language interface according to claim 38, wherein the means for forming the second n-best list includes means for assigning a recognition confidence level to each entry on the list.

55. The data selection mechanism of claim 1, operable to identify information from one or more input signal, wherein the pattern matching mechanism input is provided from one or more pre-recorded source and processing is performed without human intervention.

56. A spoken language interface mechanism comprising the data selection mechanism of claim 55, wherein input to said data selection mechanism includes at least a component of pre-recorded speech/transcription.

57. A transcription mechanism for providing said component of pre-recorded speech according to claim 56, said transcription mechanism operable to identify one or more of: a spoken name, an address, a postcode/zip code, an e-mail address, a car registration/license plate, identification numbers, policy numbers and a physical location.

58. A system comprising the data selection mechanism of claim 55, the spoken language interface mechanism of claim 56 or the transcription mechanism of claim 57.

59. A method for implementing the data selection mechanism of claim 55, the spoken language interface of claim 56 or the transcription mechanism of claim 57.

60. A computer program for implementing the method of claim 59.

61. A method of recognising an address spoken by a user using a spoken language interface, comprising:
i) forming a grammar of postcodes/zip codes;
ii) asking the user for a postcode/zip code and forming a first list of the n-best recognition results;
iii) asking the user for a street name and forming a second list of the n-best recognition results;
iv) cross matching the first and second lists to form a first list (Matches1) of valid postcode/zip code-streetname pairings; and
v) if the first list (Matches1) is positive, selecting an element from the match according to a predetermined criterion and confirming the selected match with the user.

62. The method of claim 61, further comprising:
vi) if the match is zero or the user does not confirm the match, asking the user for one or more additional items, such as a subset of the postcode/zip code, town name, district, telephone number or surname, and forming one or more additional lists of N-best recognition results;
vii) cross matching the additional lists with each other or with the first or second lists to form a subsequent match;
viii) if said subsequent match does not have a single entry, repeating the operations of obtaining additional user input, forming N-best lists and cross matching;
ix) if the subsequent match has a single entry, confirming the entry with the user; and
x) passing the user from the spoken language interface to a human operator if the user does not confirm the entry.

63. A method according to claim 61, wherein the step of forming the first list of n-best results comprises assigning a confidence level to each of the n-best results.

64. A method according to claim 61, wherein the step of forming the second list of n-best results comprises assigning a confidence level to each of the n-best results.

65. A method according to claim 64, wherein the step of selecting an element from the first match comprises selecting the element with the highest combined confidence if there are more than one matches.

66. A method according to claim 61, wherein the steps of forming the second n-best list comprises dynamically forming a grammar of street names from the postcodes comprising the first n-best list.

67. A method according to claim 61, wherein the step of forming the fourth n-best list comprises dynamically forming a grammar of town names from the first portions of the postcodes forming the third n-best list.

68. A method according to claim 61, wherein the first portion of the postcode is an area code.

69. A method according to claim 61, wherein the step of confirming a single entry comprising the second match, comprises:
cross matching the second match with the first and second n-best lists to form a third match; and confirming the third match with the user.

70. A method according to claim 69, comprising:
if the third match contains a single element, asking the user to confirm the address and postcode in that element as correct; and
if the third match contains more than one element, asking the user for a second portion of the postcode and cross matching the received second part of the postcode with the elements of the third match to form a fourth match.

71. A method according to claim 70, wherein if the fourth match has a single element, the spoken language interface asks the user to confirm the details of that element, and if the fourth match does not have a single element the user is passed to a human operator.

72. A computer program having code which, when run on a spoken language interface, causes the spoken language to perform the method of claim 61.

73. A spoken language interface operable to implement the method of claim 61.
